(19) United States
(12) Patent Application Publication
(10) Pub. No.: US 2001/0052570 A1
(43) Pub. Date: Dec. 20, 2001

(54) Radiation detection device

(75) Inventors: Tohru Ishizuya, Tokyo (JP); Junji Suzuki, Tokyo (JP); Keiichi Akagawa, Kamakura-shi (JP)

Correspondence Address: KLARQUIST SPARKMAN CAMPBELL, LEIGH & WHINSTON, LLP, One World Trade Center, Suite 1600, 121 S.W. Salmon Street, Portland, OR, 97204-2988, US

(73) Assignee: Nikon Corporation

(21) Appl. No.: 09/809,890

(22) Filed: Mar. 16, 2001

(30) Foreign Application Priority Data
Jun. 8, 2000 (JP) 2000-171627

(51) Int. Cl. G01J 5/00

(52) U.S. Cl. 250/338.1

(57) ABSTRACT

Radiation detectors are disclosed that include two electrodes (reference electrode and response electrode) that face each other and have a set gap therebetween. The electrodes are attached to the free ends of two respective displaceable members having identical structures. The displaceable members are each made of at least two layers, of different materials having different respective coefficients of thermal expansion, layered atop one another in a laminar fashion to form respective thermal bimorphs. Incident radiation is received by a radiation absorber that heats up from absorbed radiation. The heat is transferred to one of the displaceable members and exhibits a corresponding degree of bending (warping). The other displaceable member is not heated and exhibits no bending. The displaceable members are situated and configured such that each of the layers of all the displaceable members are formable simultaneously during respective fabrication steps.

### FIELD OF THE INVENTION

This invention pertains to radiation-detection devices, such as thermal infrared sensors and the like. More specifically, the invention pertains to so-called electrical-capacitance radiation detectors that convert incident radiation, such as infrared radiation, to a corresponding physical displacement of two opposing electrodes relative to each other and “read out” the displacement as a corresponding change in electrical capacitance.

### BACKGROUND OF THE INVENTION

Radiation detectors are useful for a wide variety of contemporary applications in various fields of endeavor. Various types of conventional radiation detectors are sensitive to different wavelengths of incident radiation. For example, many conventional radiation detectors are sensitive to infrared (IR) radiation and are useful for surveillance, security, heat sensing, imaging, and other applications.

An exemplary IR-radiation detector is disclosed in U.S. Pat. No. 5,623,147 to Baert et al. This detector is a so-called “electrical capacitance” type of detector. The detector comprises a substrate, a first bimetallic arm, and a second bimetallic arm. One end of each of the first and second bimetallic arms is mounted to the substrate. To the other end of the first bimetallic arm is affixed a first capacitor electrode. The second bimetallic arm is parallel to and structured similarly to the first bimetallic arm. To the other end of the second bimetallic arm is affixed a second capacitor electrode that faces and is parallel to the first electrode. A radiation-absorbing layer is thermally coupled to the first bimetallic arm but not to the second bimetallic arm. Each of the first and second bimetallic arms includes two layers made of respective materials having different coefficients of thermal expansion. Each layer extends in a respective plane that is parallel to the plane of the radiation-absorbing film. The first and second bimetallic arms (and respective electrodes) are separated from each other by an air gap extending in a “stacking direction” (i.e., a direction normal to the substrate and to the radiation-absorbing layer). Hence, when viewed from a direction normal to the plane of the radiation-absorbing layer (and thus normal to the electrodes of the first and second bimetallic arms), the first and second bimetallic arms overlap each other.

Further regarding the Baert et al. detector, whenever infrared radiation from an object is incident to the radiation-absorbing layer, the radiation is absorbed by the radiation-absorbing layer and converted to heat. The first bimetallic arm deforms (exhibits bending) in response to the heat. The second bimetallic arm exhibits substantially no deformation because essentially no heat absorbed by the radiation-absorbing layer is conducted or otherwise transmitted to the second bimetallic arm. Hence, as the first bimetallic arm deforms from absorption of heat, the gap between the first and second electrodes changes (typically becomes smaller). The magnitude of change of the gap is a function of the quantity of incident infrared radiation absorbed by the radiation-absorbing layer. As the gap changes, the electrical capacitance between the first and second electrodes correspondingly changes. Consequently, infrared radiation from the object is detected based on the electrical capacitance between the first and second electrodes.

In the Baert et al. detector, since the second electrode is affixed to the second bimetallic arm (which is structured identically to the first bimetallic arm), whenever the first bimetallic arm deforms from a change in ambient temperature, the second bimetallic arm ideally deforms by the same amount. Thus, ideally, the relative positional relationship between the first and second electrodes is unchanged with a change in ambient temperature. Purportedly, with such a configuration, infrared radiation from an object is detected accurately without the electrical capacitance between the first and second electrodes changing or being affected adversely by changes in ambient temperature. Also, especially with control of the substrate temperature being unaffected by changes in ambient temperature, strict temperature control of the overall detector is unnecessary, allowing costs to be reduced.

However, actual fabrication and operation experience with the Baert et al. detector reveals that the detector is not without significant problems. For example, in the Baert et al. detector, the first and second bimetallic arms are disposed so as to overlap each other when viewed from a normal direction, as noted above. As a result, during manufacture of the detector, one bimetallic arm must be produced displaced above the substrate and the other bimetallic arm must be produced displaced above the first bimetallic arm. Hence, the respective fabrication steps for forming the bimetallic arms must be performed separately, which substantially increases costs.

More importantly, because the first and second bimetallic arms are produced in separate fabrication steps, it is difficult to establish a desired “baseline gap” (existing gap whenever no infrared radiation is incident on the detector) between the first and second electrodes. It also is difficult to impossible to establish a consistent baseline gap from one pixel to another on the same radiation detector. The two film layers that comprise each bimetallic arm are formed extremely thin to decrease their thermal capacity and to increase responsiveness of the bimetallic arms. But, these conditions render the bimetallic arms susceptible to bending upward or downward relative to the substrate in response to residual internal stress in either film. Stress in a film can result from minute changes in film-forming conditions from one fabrication step to another that are extremely difficult to control to a sufficiently strict degree. Furthermore, because the bimetallic arms are produced in separate fabrication steps, the respective initial deformed conditions of the first and second bimetallic arms are different. Again, this difference makes it difficult to establish a desired positional relationship (e.g., gap) of the first and second electrodes. Hence, the desired sensitivity and dynamic range of infrared detection cannot be obtained on a sufficiently consistent basis to be practical.

Furthermore, the electrical capacitance between the first and second electrodes is inversely proportional to the distance between the first and second electrodes. Hence, the capacitance increases with decreasing gap. Also, the capacitance increases with changes in temperature caused by incident infrared radiation. Hence, the narrower the gap, the greater the sensitivity with which infrared radiation can be detected. But, if the electrodes were to touch each other, then any changes that may further increase the capacitance between the electrodes would not occur, thereby restricting the dynamic range. Hence, the electrodes must not touch each other.

It is preferable that the gap between the electrodes be as narrow as possible without allowing the electrodes to touch each other. But, due to the difficulty in setting the gap to a desired dimension, as discussed above, the gap usually is made larger than desired or it is accepted that the electrodes are vulnerable to touching each other, thereby decreasing detection sensitivity and undesirably limiting the dynamic range of the detector.

Another difficulty with manufacturing the first and second bimetallic arms separate fabrication steps is the difficulty in sufficiently suppressing changes in electrical capacitance between the electrodes due to changes in ambient temperature. Namely, in fabricating the first and second bimetallic arms by conventional methods, the characteristics of the films (e.g., film thickness) comprising the bimetallic arms cannot be maintained completely identical in both bimetallic arms. Since the characteristics of arm deformation from changes in temperature depend upon the film characteristics, the respective deformations of the first and second arms from temperature changes will not be identical. This difference causes a corresponding change in capacitance between the electrodes with changes in ambient temperature. The capacitance change, unfortunately, can be relatively large, which renders the conventional device impractical for many uses.

### SUMMARY OF THE INVENTION

In view of the shortcomings of the prior art as summarized above, an object of the invention is to provide radiation detectors based on electrical capacitance between electrodes, wherein the gap between the electrodes can be set to a desired distance, to produce detectors capable of providing the desired sensitivity characteristics and the desired dynamic range in radiation detection.

Another object is to provide radiation detectors exhibiting superior suppression of changes in the electrical capacitance between electrodes due to changes in ambient temperature changes, thereby providing improved detection accuracy than conventional detectors.

According to a first aspect of the invention, radiation detectors are provided that achieve the objects noted above. Such a radiation detector includes a substrate on which at least one “unit pixel” (detection unit) is formed. An embodiment of a radiation detector according to the invention comprises first and second displaceable members attached to the substrate. The displaceable members have similar respective thermally bimorphous structures. A first electrode is attached to the first displaceable member, and a second electrode is attached to the second displaceable member such that at least a portion of the second electrode faces the first electrode. The radiation detector includes a radiation absorber configured to absorb incident radiation to be detected. The radiation absorber is thermally coupled to the first displaceable member but substantially not to the second displaceable member so as to enable the radiation absorber, when heated by absorption of incident radiation, to transfer heat to the first displaceable member but substantially not to the second displaceable member. Each of the first and second displaceable members includes at least a first and a second layer laminated together in a “stacking direction” (normal to the substrate) to form the respective thermally bimorphous structure. The first and second layers are formed of respective first and second materials having different respective coefficients of thermal expansion so as to cause a displaceable member to exhibit a bending response when heated. The bending response occurring in one displaceable member (typically the first displaceable member thermally coupled to the radiation absorber) but substantially not in the other results in a corresponding change in a gap distance between the first and second electrodes. (The amount of bending exhibited by the displaceable member exhibiting “substantially” no bending response does not, within an acceptable tolerance, alter the apparent quantity of radiation corresponding to the bending exhibited by the displaceable member coupled to the radiation absorber.) The first and second electrodes are configured to allow an electrical capacitance to be measured between the first and second electrodes. The electrical capacitance exhibits a change with a respective change in the gap distance. The first and second displaceable members are situated relative to each other such that the first and second layers of each of the first and second displaceable members are formable simultaneously during respective fabrication steps.

Hence, with this embodiment, whenever radiation (e.g., infrared, X-rays, or ultraviolet radiation) is incident to the radiation absorber, the radiation is absorbed by the radiation absorber and converted to heat, and the first displaceable member bends (“deflects” or “warps”) in response to the heat. Meanwhile, the second displaceable member exhibits substantially no bending because no more than an insignificant amount of the heat generated in the radiation absorber is transmitted to the second displaceable member. The gap distance between the first and second electrodes changes in response to the bending of the first displaceable member. As the gap distance changes, a corresponding change occurs in the electrical capacitance of the first and second electrodes.

By situating the first and second displaceable members relative to each other such that the first and second layers of each of the first and second displaceable members are formable simultaneously during respective steps, the first and second displaceable members are situated such that they do not overlap each other when viewed from the stacking direction. (As noted above, the “stacking direction” is normal to the substrate. The “stacking” referred to is the stacking or lamination of the first and second layers of the displaceable members. Hence, the stacking direction is the direction in which the second layer is formed relative to the first layer.) “Formable simultaneously” as used above means that, for example, the first (also termed “lower”) layer of both displaceable members is formed during a single fabrication step. Similarly, the second (also termed “upper”) layer of both displaceable members is formed during a different, but nevertheless single, fabrication step.

By fabricating the first and second displaceable members in the manner summarized above, even if the first and second displaceable members should exhibit an initial warp due to stress in one or both the first and second layers, the degree of warp of both displaceable members is substantially identical. Consequently, the “baseline” gap distance between the first and second electrodes is unchanged by the initial warp. (A “baseline” gap distance is the distance between the first and second electrodes whenever the subject pixel is not receiving any significant amount of incident radiation to be measured.) Desirably, the first and second displaceable members are situated laterally adjacent each other (and hence parallel to each other) on the substrate so as to reduce further any relative displacements of the first and second displaceable members due to stress arising at one location during layer formation but not at another location.

Another advantage in forming the first and second layers during the same respective fabrication steps is that any differences in layer characteristics (e.g., layer thickness) of the first and second displaceable members are reduced to insignificant levels. Consequently, differences in bending characteristics of the first and second displaceable members due to temperature changes are considerably reduced compared to conventional radiation detectors. Hence, even if the substrate temperature is not controlled strictly during use of the radiation detector, changes in electrical capacitance between the electrodes due to changes in ambient temperature are reduced appreciably, compared to conventional radiation detectors. As a result, incident radiation is detected with greater accuracy than obtainable using a conventional radiation detector. Again, the first and second displaceable members desirably are situated adjacent each other to avoid stress differences from one location to another on the substrate.

When using a radiation detector according to the invention, the effects of changes in ambient temperature can be eliminated by placing the radiation detector in a vacuum chamber or by strictly controlling substrate temperature during use of the detector. Even under such conditions, the second displaceable member continues to preserve the gap distance between the first and second electrodes whenever no radiation to be measured is incident to the radiation absorber.

The radiation detector of this embodiment further can comprise a radiation reflector. In such a configuration, the radiation absorber reflects a portion of radiation incident to it. The radiation reflector desirably is situated relative to the radiation absorber so as to define a gap of substantially nλ₀/4 between the radiation absorber and the radiation reflector. In this expression, n is an odd integer and λ₀ is the center wavelength of a wavelength band of radiation detectable by the radiation detector. Hence, for example, whenever radiation is incident to the radiation absorber from an opposite side of the radiation reflector, part of the incident radiation is absorbed by the radiation absorber, while the remainder is reflected by the radiation reflector. The latter reflected radiation is reflected back and forth in the gap between the radiation absorber and the radiation reflector to produce interference. Since the gap is roughly an odd-integer multiple of one-fourth of the central wavelength of the desired wavelength band of incident radiation, radiation absorption by the radiation absorber is maximized. This increases the efficiency of radiation absorption and detection even with reduction in the thickness and/or thermal capacity of the radiation absorber.

By way of example, the percentage of incident radiation reflected from the radiation absorber is approximately 33% (approximately ⅓), to increase further the percentage of radiation absorbed at the radiation absorber.

The radiation reflector desirably is one of the first and second electrodes. With such a configuration, the radiation absorber is situated in the stacking direction relative to the first and second electrodes. This configuration achieves simplification of the overall structure of the radiation detector. Also, by disposing the radiation absorber in the stacking direction, the respective surface areas of the radiation absorber and/or of both electrodes can be increased, thereby improving detector sensitivity.

The first and second electrodes and the radiation absorber can be aligned with each other and arranged in the stacking direction in an order of: (a) radiation absorber, first electrode, then second electrode, or (b) radiation absorber, second electrode, then first electrode. In either of these configurations, the first displaceable member, when heated, exhibits a bending response that that displaces the second electrode away from the first electrode. The bending response also can be characterized by a so-called “knee characteristic,” in which sensitivity of the detector at room temperature to incident radiation is relatively high while sensitivity at higher temperatures is relatively low. In addition, by situating the first electrode between (in the stacking direction) the radiation absorber and the second electrode, even though the radiation absorber is thermally coupled (and consequently also mechanically coupled) to the first electrode, circumstances can be avoided in which the bending range of the first displaceable member is restricted by the radiation absorber touching the second electrode, or similar conditions. This allows the dynamic range of detection to be enlarged appreciably over conventional radiation detectors.

The first electrode desirably comprises a planar portion (desirably parallel to the substrate). The first electrode also desirably includes a side portion extending at least partially around the periphery of the planar portion. The side portion desirably projects from the planar portion away from the second electrode. Similarly, the second electrode comprises a planar portion and a side portion that extends at least partially around the periphery of the planar portion. The side portion of the second electrode extends from the planar portion away from the first electrode. By configuring both electrodes with respective planar portions and side portions, the electrodes are reinforced structurally by the side portions. This allows the thickness of each electrode to be reduced, with concomitant reductions in the respective thermal capacities of the electrodes, without compromising strength. By configuring the respective side portions to extend away from each other, the side portions do not interfere with each another during instances in which the gap between the first and second electrodes is narrowed. This, in turn, allows the gap between the first and second electrodes to be made narrower, with accompanying increases in detector sensitivity compared to conventional detectors.

One of the first and second electrodes can be affixed via a support frame to the respective first or second displaceable member. The support frame desirably is made of a thermally insulative material and comprises a planar portion and a side portion extending from the planar portion along at least a portion of the periphery of the planar portion. The side portion serves to strengthen the planar portion of the support frame in a manner as described above with respect to the first and second electrodes.

The radiation detector further can comprise an electrically insulative film situated “between” the first electrode and the second electrode. E.g., the insulative film can be situated on one or the other of the electrodes. The insulative film serves to prevent electrical shorts between the first and second electrodes even whenever the gap between the electrodes is reduced to zero. The total surface area of the insulative film desirably is low relative to the area of either of the electrodes to avoid significant alteration of the thermal capacity of the respective electrode. Hence, the insulating film can be configured as small regions (“spots”) provided at multiple disparate locations.

The radiation detector further can comprise first and second legs, wherein the first displaceable member is mounted to the substrate via the first leg, and the second displaceable member is mounted to the substrate via the second leg. As described in detail herein, each leg has a respective length direction, a start point, and an end point. With respect to the first leg, the distance along the respective length direction from the respective start point to the respective end point can be substantially equal to, with respect to the second leg, the distance along the respective length direction from the respective start point to the respective end point. By configuring these distances to be equal, the elevations and angles (relative to the substrate) of the respective end points of the first and second legs (and consequently, the respective start points of the first and second displaceable members) can be kept equal, even whenever the first and second legs are initially warped from stress generated during fabrication.

In this configuration, the end point of the first leg can be located in the first displaceable member, and the end point of the second leg can be located in the second displaceable member. The “start point of a displaceable member” means an edge point on the substrate side of the respective displaceable member, or alternatively an edge point on the electrode side of the respective displaceable member. The lengths desirably are equal because, in such a configuration, the angles at the end points of the first and second displaceable members, relative to the substrate, are equal in an initial state of the detector in which there is no radiation incident on the detector.

Alternatively, with respect to the second leg, the distance along the respective length direction from the respective start point to the respective end point can be shorter than, with respect to the first leg, a distance along the respective length direction from the respective start point to the respective end point. This modification includes configurations in which the second leg has zero length, along the length direction, between the start point and the end point. These configurations are especially effective in instances in which the first and second legs are not warped, wherein the respective elevations (above the substrate) and angles at the respective end points of the first and second legs (and, consequently, the start points of the first and second displaceable members) are equal. By reducing the length of the second leg, even to zero length, the area normally occupied by the second leg is eliminated.

In yet another alternative configuration, the start point of the first displaceable member and the start point of the second displaceable member have substantially identical positions when viewed from the width direction of the first and second displaceable members. In such a configuration, the heights of the first and second displaceable members, relative to the substrate, are equal in an initial state of the detector in which no radiation is incident on the detector. This can be advantageous because the relative positional relationship between the first and second electrodes is virtually unchanged with changes in ambient temperature.

In yet another alternative configuration, the start point of the first displaceable member and the start point of the second displaceable member are shifted relative to each other to form a gap between the first and second displaceable members. The gap is narrowed when viewed from the width direction of the first and second displaceable members. With such a configuration, the gap distance between the first and second electrodes can be made very narrow, which serves to increase the detection sensitivity of the radiation detector.

The radiation detector can be configured such that the first and second legs, the first and second displaceable members, the first and second electrodes, and the radiation absorber are disposed in the stacking direction with respective intervening spaces therebetween. With such a configuration, the respective surface areas of the radiation absorber and/or both electrodes inside any given area can be increased, thereby improving detection sensitivity. However, the overall structure does not exhibit substantial horizontal “spread,” which allows an increase in fill factor without sacrificing strength.

Any of the radiation detectors according to the invention can include one or multiple unit pixels. In detectors comprising multiple unit pixels, the unit pixels may be arranged one- or two-dimensionally. Detectors comprising only one pixel can be used to detect the presence or absence of radiation. Detectors comprising multiple pixels (especially arranged in two dimensions) can be used to detect images.

According to another aspect of the invention, methods are provided for fabricating, on a substrate, a radiation detector including at least one unit pixel. In an embodiment of such a method, a first layer-forming step comprises forming a first layer, of a first material having a respective coefficient of thermal expansion, of each of first and second displaceable members. In a second layer-forming step, a second layer, of a second material having a respective coefficient of thermal expansion that is different from the coefficient of thermal expansion of the first material, is formed of each of the first and second displaceable members to form respective thermally bimorphous structures in which the respective first and second layers are laminated together. A first electrode is formed, attached to the first displaceable member. A second electrode also is formed, attached to the second displaceable member such that at least respective portions of the first and second electrodes face each other in a stacking direction with a space therebetween. Also, the electrodes are formed such that an electrical capacitance can be measured between the first and second electrodes. A radiation absorber is formed in a manner and location such that the radiation absorber is thermally coupled to the first displaceable member but not to the second displaceable member. The radiation absorber is formed of a material that absorbs incident radiation that causes heating of the radiation absorber with resultant conduction of the heat to the first displaceable member.

The first and second electrodes and the radiation absorber can be formed in any of various orders of steps. One example order is, from the substrate in a stacking direction, first electrode, second electrode, then radiation absorber. Another example order is, from the substrate in a stacking direction, second electrode, first electrode, then radiation absorber. Yet another example order is, from the substrate in a stacking direction, radiation absorber, first electrode, then second electrode. Yet another example order is, from the substrate in a stacking direction, radiation absorber, second electrode, then first electrode.

The foregoing and additional features and advantages of the invention will be more readily apparent from the following detailed discussion, which proceeds with reference to the accompanying drawings.

### BRIEF DESCRIPTION OF THE DRAWINGS

FIG. 1 is a schematic plan view of a unit pixel of a first representative embodiment of a radiation detector according to the invention.

FIG. 2 is a schematic elevational section along the line X1-X2 in FIG. 1.

FIG. 3 is a schematic elevational section along the line X3-X4 in FIG. 1.

FIG. 4 is a schematic elevational section along the line X5-X6 in FIG. 1.

FIG. 5 is a schematic elevational section along the line X7-X8 in FIG. 1.

FIG. 6 is a schematic elevational section along the line X17-X18 in FIG. 1.

FIG. 7 is a schematic elevational section along the line X19-X20 in FIG. 1.

FIG. 8 is a schematic elevational section along the line Y1-Y2 in FIG. 1.

FIG. 9 is a schematic elevational section along the line Y3-Y4 in FIG. 1.

FIG. 10 is a schematic plan view of a unit pixel, of the first representative embodiment, corresponding to FIG. 1 but with additional sectional lines and points indicated.

FIG. 11 is a schematic elevational section along the line A1-A16 in FIG. 10.

FIG. 12 is a schematic plan view showing results of a first step in a method for fabricating a radiation detector according to the first representative embodiment.

FIG. 13 is a schematic elevational section along the line Y5-Y6 in FIG. 12.

FIG. 14 is a schematic plan view showing results of a step, subsequent to the step shown in FIG. 12, in the method for fabricating a radiation detector according to the first representative embodiment.

FIG. 15 is a schematic elevational section along the line X1′-X2′ in FIG. 14.

FIG. 16 is a schematic plan view showing results of a step, subsequent to the step shown in FIG. 14, in the method for fabricating a radiation detector according to the first representative embodiment.

FIG. 17 is a schematic plan view showing results of a step, subsequent to the step shown in FIG. 16, in the method for fabricating a radiation detector according to the first representative embodiment.

FIG. 18 is a schematic plan view showing results of a step, subsequent to the step shown in FIG. 17, in the method for fabricating a radiation detector according to the first representative embodiment.

FIG. 19 is a schematic plan view showing results of a step, subsequent to the step shown in FIG. 18, in the method for fabricating a radiation detector according to the first representative embodiment.

FIG. 20 is a schematic plan view showing results of a step, subsequent to the step shown in FIG. 19, in the method for fabricating a radiation detector according to the first representative embodiment.

FIG. 21 is a schematic plan view showing results of a step, subsequent to the step shown in FIG. 20, in the method for fabricating a radiation detector according to the first representative embodiment.

FIG. 22 is a schematic plan view showing results of a step, subsequent to the step shown in FIG. 21, in the method for fabricating a radiation detector according to the first representative embodiment.

FIG. 23 is a schematic plan view showing results of a step, subsequent to the step shown in FIG. 22, in the method for fabricating a radiation detector according to the first representative embodiment.

FIG. 24 is a schematic elevational section along the line X17′-X18′ in FIG. 23.

FIG. 25 is a schematic elevational section along the line X19′-X20′ in FIG. 23.

FIG. 26 is a schematic elevational section along the line Y1′-Y2′ in FIG. 23.

FIGS. 27(a)-27(c) depict a modeled example of an initial condition of the radiation detector of the first representative embodiment.

FIGS. 28(a)-28(c) depict another modeled example of an initial condition of the radiation detector of the first representative embodiment.

FIGS. 29(a)-29(c) depict yet another modeled example of an initial condition of the radiation detector of the first representative embodiment.

FIGS. 30(a)-30(c) depict a modeled example of an initial condition of the radiation detector of a first modification of the first representative embodiment.

FIGS. 31 (a)-31(c) depict a modeled example of an initial condition of the radiation detector of a second modification of the first representative embodiment.

FIG. 32 is a schematic plan view of a unit pixel of a second representative embodiment of a radiation detector according to the invention.

FIG. 33 is a schematic elevational section along the line X33-X34 in FIG. 32.

FIG. 34 is a schematic elevational section along the line Y11-Y12 in FIG. 32.

FIG. 35 is a schematic plan view of a unit pixel of a third representative embodiment of a radiation detector according to the invention.

FIG. 36 is a schematic plan view of a unit pixel of a fourth representative embodiment of a radiation detector according to the invention.

FIG. 37 is a schematic plan view of a unit pixel of a fifth representative embodiment of a radiation detector according to the invention.

FIG. 38 is a schematic plan view of a unit pixel of a sixth representative embodiment of a radiation detector according to the invention.

FIG. 39 is a schematic elevational section along the line X51-X52 in FIG. 38.

FIG. 40 is a schematic elevational section along the line X53-X54 in FIG. 38.

FIG. 41 is a schematic elevational section along the line Y51-Y52 in FIG. 38.

FIG. 42 is a schematic elevational section along the line Y53-Y54 in FIG. 38.

FIG. 43 is a schematic plan view showing results of a first step in a method for fabricating a radiation detector according to the sixth representative embodiment.

FIG. 44 is a schematic elevational section along the line X70-X71 in FIG. 43.

FIG. 45 is a schematic plan view showing results of a step, subsequent to the step shown in FIG. 43, in the method for fabricating a radiation detector according to the sixth representative embodiment.

FIG. 46 is a schematic plan view showing results of a step, subsequent to the step shown in FIG. 45, in the method for fabricating a radiation detector according to the sixth representative embodiment.

FIG. 47 is a schematic plan view showing results of a step, subsequent to the step shown in FIG. 46, in the method for fabricating a radiation detector according to the sixth representative embodiment.

FIG. 48 is a schematic plan view showing results of a step, subsequent to the step shown in FIG. 47, in the method for fabricating a radiation detector according to the sixth representative embodiment.

FIG. 49 is a schematic plan view showing results of a step, subsequent to the step shown in FIG. 48, in the method for fabricating a radiation detector according to the sixth representative embodiment.

FIG. 50 is a schematic plan view showing results of a step, subsequent to the step shown in FIG. 49, in the method for fabricating a radiation detector according to the sixth representative embodiment.

FIG. 51 is a schematic plan view showing results of a step, subsequent to the step shown in FIG. 50, in the method for fabricating a radiation detector according to the sixth representative embodiment.

FIG. 52 is a schematic plan view showing results of a step, subsequent to the step shown in FIG. 51, in the method for fabricating a radiation detector according to the sixth representative embodiment.

FIG. 53 is a schematic plan view showing results of a step, subsequent to the step shown in FIG. 52, in the method for fabricating a radiation detector according to the sixth representative embodiment.

FIG.54 is a schematic plan view showing results of a step, subsequent to the step shown in FIG. 53, in the method for fabricating a radiation detector according to the sixth representative embodiment.

FIG. 55 is a schematic plan view showing results of a step, subsequent to the step shown in FIG. 54, in the method for fabricating a radiation detector according to the sixth representative embodiment.

FIG. 56 is a schematic elevational section along the line X51′-X52′ in FIG. 55.

FIG. 57 is a schematic elevational section along the line X53′-X54′ in FIG. 55.

FIG. 58 is a schematic elevational section along the line Y51′-Y52′ in FIG. 55.

### DETAILED DESCRIPTION

This invention is described below in the context of representative embodiments that are not intended to be limiting in any way. Also, the invention is described in the context of the incident radiation being infrared radiation. However, it will be understood that the incident radiation alternatively can have any of various wavelengths, other than infrared, (e.g., visible, ultraviolet, X-ray) capable of causing heating of a radiation-absorbing material on which the radiation is incident.

### First Representative Embodiment

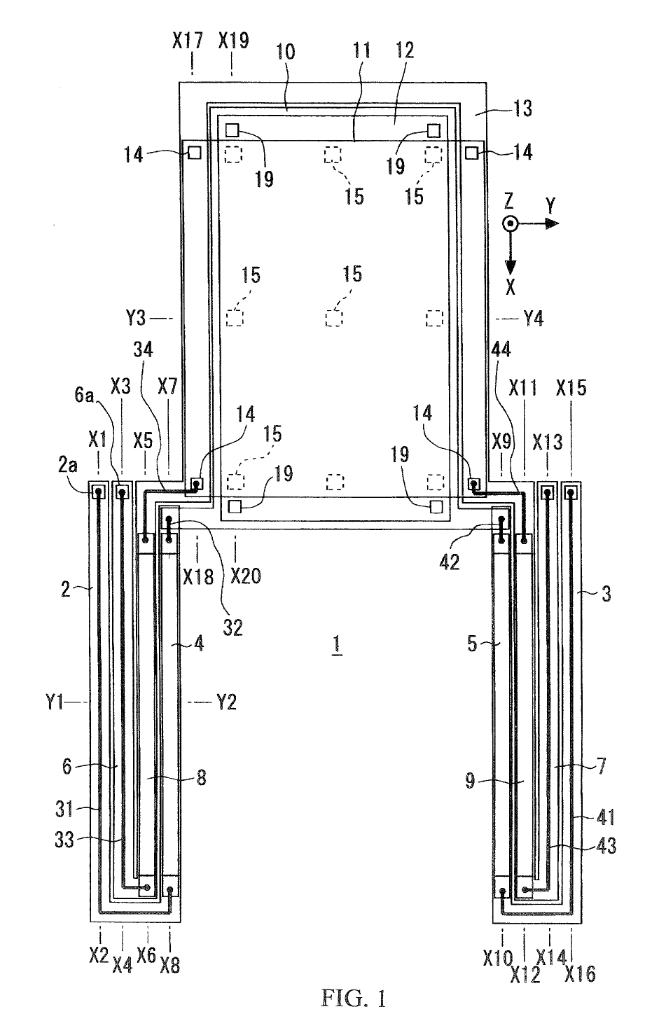

FIG. 1 is a schematic plan view drawing showing a unit “pixel” (unit element) of a radiation detector according to this embodiment. To aid the discussion, in FIG. 1, hidden lines that otherwise would be indicated as broken lines are shown as solid lines, and lines denoting a difference in “height” (elevation from the plane of the page) have been omitted. The mutually orthogonal X-axis, Y-axis, and Z-axis referred to below are as indicated in FIG. 1.

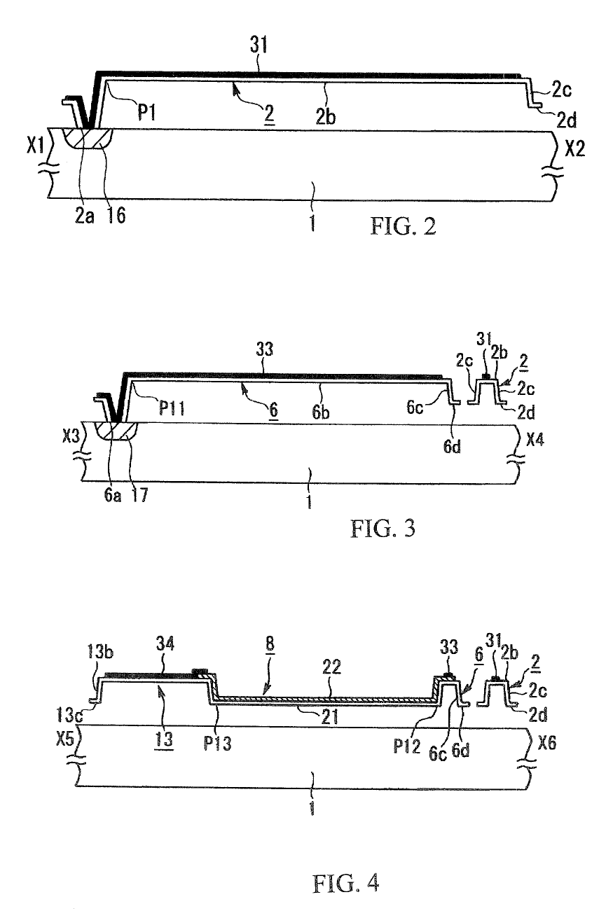

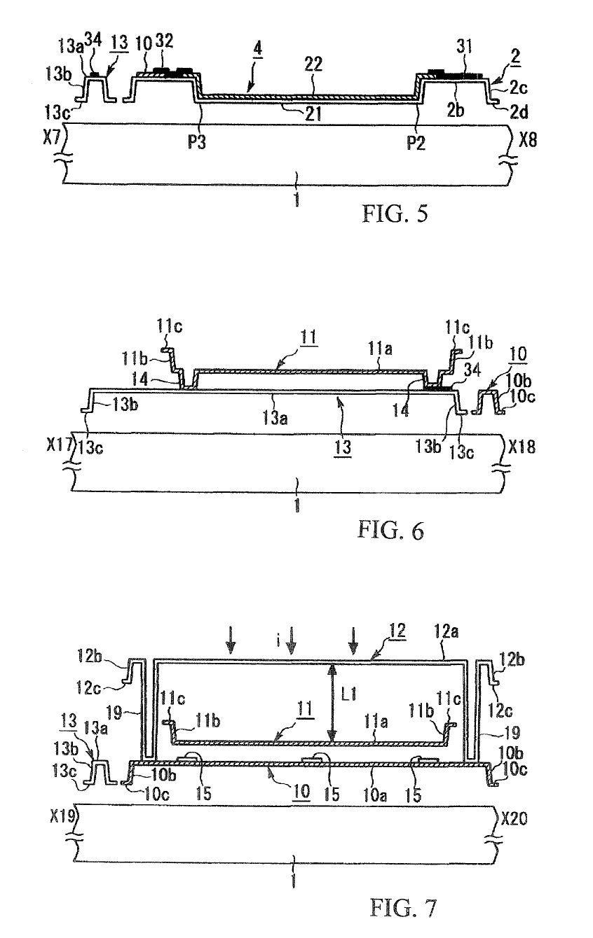

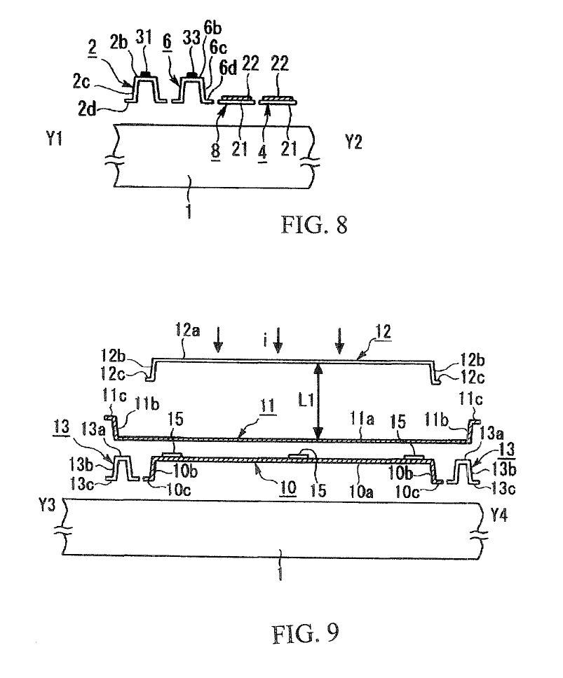

FIG. 2 is a schematic elevational section along the line X1-X2 line in FIG. 1. FIG. 3 is an schematic elevational section along the line X3-X4 in FIG. 1. FIG. 4 is a schematic elevational section along the line X5-X6 in FIG. 1. FIG. 5 is a schematic elevational section along the line X7-X8 in FIG. 1. FIG. 6 is a schematic elevational section along the line X17- X18 in FIG. 1. FIG. 7 is a schematic elevational section along the line X19-X20 in FIG. 1. FIG. 8 is a schematic elevational section along the line Y1-Y2 in FIG. 1. FIG. 9 is a schematic elevational section along the line Y3-Y4 in FIG. 1. Although not illustrated in these figures, and with respect to FIG. 1, a schematic elevational section along the line X9-X10 would be similar to FIG. 5, a schematic elevational section along the line X11-X12 would be similar to FIG. 4, a schematic elevational section along the line X13-X14 would be similar to FIG.3, and a schematic elevational section along the line X15-X16 would be similar to FIG. 2.

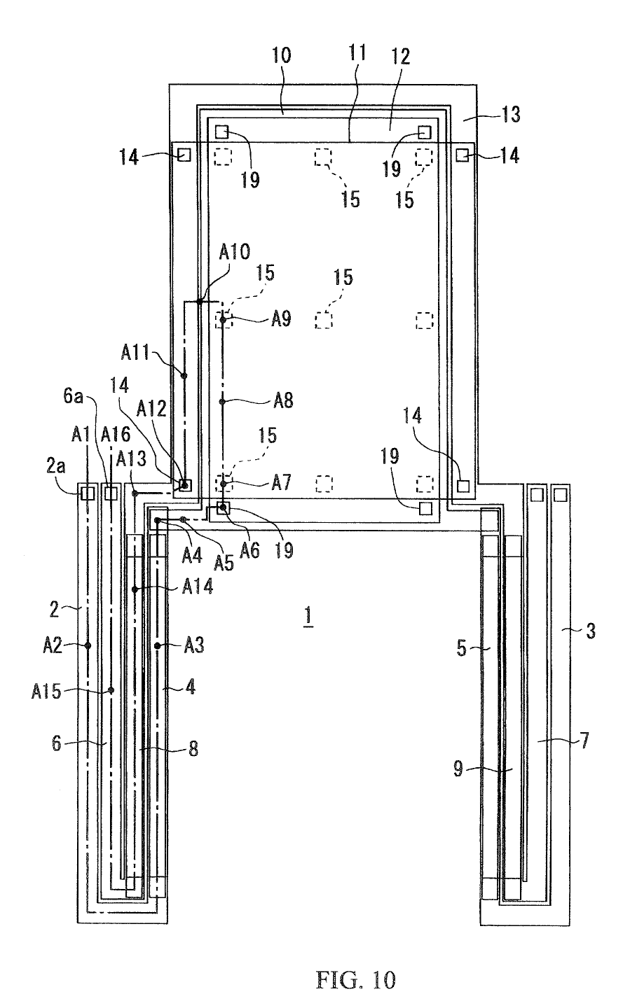

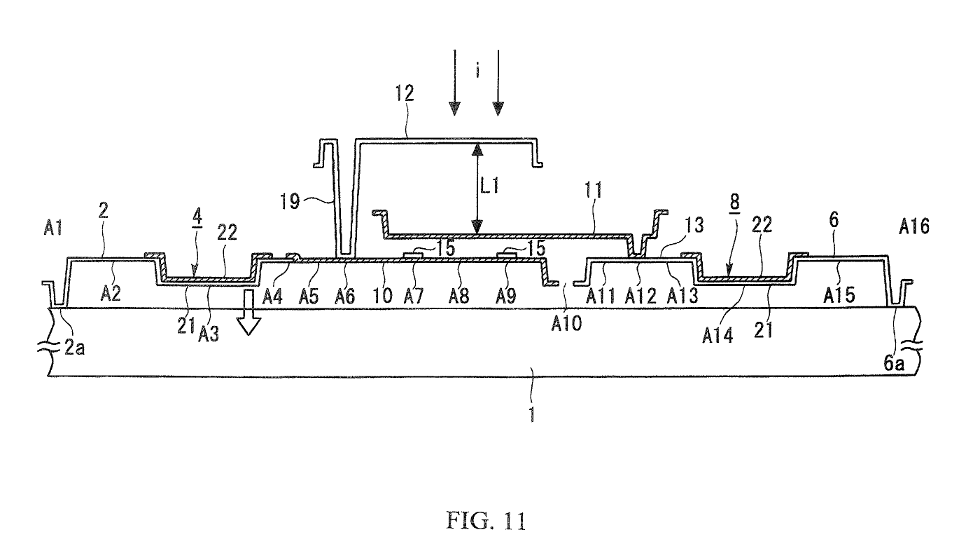

FIG. 10 is a schematic plan view that is identical to FIG. 1, except that the wiring layers 31-34 and 41-44 are omitted, and points A2-A15 have been added to denote respective points along a convoluted elevational section A1-A16 as shown in FIG. 11. In FIG. 11, the wiring layers 31-34 and 41-44 also have been omitted, and the points A2-A15 in FIG. 11 indicate the same points as respectively shown in FIG. 10.

The radiation detector of this embodiment comprises a substrate 1. The substrate is understood to be a substantially planar body presenting a major surface extending parallel with the X-Y plane, upon which various layers comprising the structure of the radiation detector are formed during respective fabrication steps. The substrate 1 typically is made of silicon (Si) or other suitable material that desirably is transmissive to infrared (IR) radiation. In the depicted pixel (FIG. 1), two legs 2, 3 extend upward (in the Z-axis direction) and extend substantially parallel to (mainly in the X-axis direction) the substrate 1. The legs 2, 3 support respective displaceable members 4, 5 that are supported on the substrate 1 by the legs 2, 3, respectively. Also extending upward from and substantially parallel to the substrate are two legs 6, 7 that support respective displaceable members 8, 9. A first electrode (hereinafter termed a “response electrode”) 10 is affixed to the first displaceable members 4, 5, and a second electrode (hereinafter termed the “reference electrode”) 11 is affixed to the second displaceable members 8, 9. At least a portion of the reference electrode 11 faces the response electrode 10 and is separated (in the Z-direction) from the response electrode 10 by a defined gap. A radiation absorber 12 (that absorbs incident radiation i) is thermally coupled to the first displaceable members 4, 5, but not to the second displaceable members 8, 9. As can be ascertained, the IR radiation i is incident on the detector without first passing through the substrate 1 (FIGS. 7 and 9).

The depicted pixel in FIG. 1 indicates that each constituent pixel in the radiation detector of this embodiment is bilaterally symmetrical. Hence, the legs 3, 7 and respective displaceable members 5, 9 correspond to the legs 2, 6 and displaceable members 4, 8, respectively. In view of these similarities, description of the legs 3, 7 and of the respective displaceable members 5, 9 is omitted in the discussion below. However, it will be understood that discussion below pertaining to the legs 2, 6 and displaceable members 4,8 also is applicable to the legs 3, 7 and displaceable members 4, 8, respectively.

In this embodiment, two sets (each consisting of two respective legs and two respective displaceable members) are provided to confer mechanical stability to the pixel structure. More generally, the radiation detector can comprise one or more sets of legs per pixel.

The legs 2, 6 are constructed of a highly adiabatic (thermally insulative) material (e.g., SiN). Desirably, each leg 2, 6 is constructed of the same material and has the same width (in the Y-direction) and thickness (in the Z-direction). The legs 2, 6 are attached to the substrate 1 by respective contact points 2a, 6a. Thus attached to the substrate, the legs 2, 6 have respective planar portions 2b, 6b that extend substantially parallel to the substrate 1. The planar portions 2b, 6b have respective L-shaped configurations in which the respective long portion extends primarily in the X-axis direction. Extending from the planar portions 2b, 6b toward the substrate 1 are respective “vertical” side portions 2c, 6c (FIGS. 2-5 and 8). The side portions 2c, 6c can be edged with respective “horizontal” edge portions 2d, 6d that extend outward from the respective side portion 2c, 6c parallel to the substrate. In an alternative configuration, the edge portions 2d, 6d are deleted.

Since the planar portions 2b, 6b are reinforced structurally by the side portions 2c, 6c, the layers constituting the planar portions 2b, 6b can be made thinner than conventionally, while still providing substantial mechanical strength to the planar portions 2b, 6b. Consequently, deformation of the legs 2, 6 due to insufficient mechanical strength is prevented, and the heat-insulating properties of the legs 2, 6 are increased compared to conventional devices. Since the heat-insulating properties of the leg 2 (and leg 3) are increased, displacement of the displaceable member 4 (and displaceable member 5) accurately corresponds to the amount of incident radiation that is absorbed. This allows the signal-to-noise (S/N) ratio of radiation detection using this embodiment to be increased compared to conventional radiation detectors.

As shown in FIGS. 4 and 5, each of the displaceable members 4, 8 is constructed of two films 21, 22 layered superposedly in the Z-axis direction (the “vertical” direction in the figure). As discussed later below, the films 21 and 22 of each displaceable member 4, 8 are formed simultaneously during respective fabrication steps to ensure that each film 21, 22 of the radiation detector is formed under identical respective conditions. One end of each displaceable member 4, 8 is connected to and supported by a respective leg 2, 6 to form a respective cantilevered structure (see especially FIG. 5) in which the respective displaceable member 4, 8 is “horizontally” suspended (i.e., “floating”) above the substrate 1. The displaceable members 4, 8 extend parallel to each other longitudinally along the X-axis. Thus, in this embodiment, the displaceable members 4, 8 are not arranged superposedly relative to each other when viewed from a Z-axis direction, but rather are disposed side-by-side, as shown in FIG. 1.

The films 21, 22 are constructed of different materials with mutually different coefficients of thermal expansion. Hence, the displaceable members 4, 8 effectively comprise respective so-called “thermally bimorphous” structures (also termed “bimetallic” elements). Whenever the coefficient of thermal expansion of the “lower” film 21 is lower than the coefficient of thermal expansion of the “upper” film 22, heating a displaceable member 4, 8 causes the respective displaceable member to bend or deflect “downward” (toward the substrate 1). Conversely, whenever the coefficient of thermal expansion of the lower film 21 is greater than the coefficient of thermal expansion of the upper film 22, heating a displaceable member 4, 8 causes the respective displaceable member to bend or deflect “upward” (away from the substrate). The degree of bending is a function of the amount of heating experienced by the respective displaceable member.

By way of example, in this embodiment, the lower film 21 is SiN and the upper film 22 is Al (the thermal expansion coefficient of Al is greater than the thermal expansion coefficient of SiN). The films 21, 22 constituting the displaceable member 4 are identical to respective films 21, 22 constituting the displaceable member 5. This identity extends not only to respective materials of which the films are made but also to respective widths, lengths, and thicknesses of the films.

In this embodiment, the SiN lower film 21 of the displaceable member 4 is formed as an extension of the SiN film used to form the leg 2. Similarly, the SiN lower film 21 of the displaceable member 8 is formed as an extension of the SiN film used to form the leg 6.

The response electrode 10 is configured as a metal (desirably aluminum) layer that is suspended above the substrate 1. To such end, the response electrode 10 is attached at respective locations to free ends of the displaceable members 4 and 5 (these “free” ends are opposite respective ends that are connected to the legs 2 and 3). As shown in FIG. 1, to facilitate such attachment of the response electrode 10, the aluminum (Al) layer comprising the response electrode 10 has two opposing ears that overlap the respective free ends of the displaceable members 4, 5. This overlap is achieved at the time the Al layer of the response electrode 10 is formed, wherein the ears of the response electrode are layered over the SiN free ends of the displaceable members 4, 5 (see also FIGS. 5 and 6).

Referring to FIG. 7, the response electrode 10 comprises a planar portion 10a that extends roughly parallel with the substrate 1 and a “vertical” side portion 10b that extends around nearly the entire periphery of the planar portion 10a. The side portion 10b extends toward the substrate 1. The response electrode 10 also can include an edge portion 10c extending outward, parallel to the substrate 1, from the “lower” edge of the side portion 10b. The edge portion 10c is optional and may be omitted. The side portion 10b serves to reinforce the planar portion 10a structurally, allowing the planar portion 10a to be made thinner than conventionally without sacrificing the strength of the response electrode 10.

The reference electrode 11 is situated so as to face the “upper” surface of the response electrode 10 with a gap between the electrodes 10, 11. The reference electrode 11 is attached at respective locations to free ends of the displaceable members 8, 9 (these free ends are opposite respective ends of the displaceable members that are connected to the legs 6, 7 respectively). More specifically, the reference electrode 11 is attached to a support frame 13 that, in turn, is attached to the free ends. The support frame 13 is configured from a layer of SiN or other suitable adiabatic material.

During fabrication, the support frame 13 is formed as an extension of the lower SiN films 21 of the displaceable members 8, 9. More specifically, the support frame 13 extends from the free ends of the displaceable members 8, 9, as shown in FIG. 1 (see also FIGS. 4-7 and 9). The support frame 13 thus extends in a squared U-shaped profile (FIG. 1) around the periphery of the response electrode 10. The support frame 13 includes a planar portion 13a extending roughly parallel to the substrate 1 and a side portion 13b extending along nearly the entire inner and outer periphery of the planar portion 13a. The side portion 13b extends roughly in the Z-direction from the planar portion 13a toward the substrate 1. The side portion 13b optionally can be edged with an edge portion 13c that extends parallel to the substrate slightly outward from the side portion 13b. The edge portion 13c may be omitted if desired. Since the planar portion 13a is reinforced structurally by the side portion 13b, the planar portion 13a can be made thinner than conventionally, without sacrificing the mechanical strength of the planar portion 13a.

The reference electrode 11 comprises an aluminum (Al) layer defining a planar portion 11a that is roughly parallel with the substrate 1. The reference electrode also includes a side portion 11b extending along nearly the entire edge of the planar portion 11a and projecting roughly in the Z-direction from the planar portion away from the substrate 1 and response electrode 10 (FIGS. 6, 7, and 9). The side portion 11b optionally can be edged with an edge portion 11c that extends parallel to the substrate slightly outward from the side portion 11b. The edge portion 11c can be omitted if desired. Since the planar portion 11a is reinforced structurally by the side portion 11b, the planar portion 11a can be made thinner than conventionally, without sacrificing the mechanical strength of the planar portion 11a. Moreover, because the side portion 11b of the reference electrode 11 extends in a direction opposite the direction in which the side portion 10b of the response electrode 10 extends, the side portions 10a, 11a do not obstruct each other whenever the gap between the first and second electrodes 10, 11 narrows. This allows IR-detection sensitivity to be increased by narrowing the gap between the electrodes 10, 11.

The reference electrode 11 is attached at each of its corners to the planar portion 13a of the support frame 13 via connecting posts 14 extending from the planar portion of the reference electrode 11. Thus, the reference electrode is attached to the free ends of the displaceable members 8, 9 via the support frame 13. The connecting posts 14 are extensions (roughly in the Z-direction) of the Al layer comprising the reference electrode 11.

Localized regions (pads) 15 of an electrically insulating film are disposed on the “upper” surface of the planar portion 10a so as to be located “between” the response electrode 10 and reference electrode 11, as shown in FIGS. 1, 7, and 9. The pads 15 of insulating film prevent electrical shorts that otherwise could result if the electrodes 10, 11 were to contact each other. The insulating film desirably is made of SiN, and the pads 15 desirably are small relative to the area of the planar portion 10a to minimize any adverse effect of the pads 15 on the thermal capacity of the response electrode 10.

Respective diffusion zones 16, 17 are situated in the substrate 1 “below” the contact points 2a, 6a of the legs 2, 6, respectively, as shown in FIGS. 2 and 3. The leg 2 includes a wiring layer 31 (FIGS. 1-5 and 8) that electrically connects the diffusion zone 16 with the upper film 22 of the displaceable member 4. The contact point 2a defines an opening through which the wiring layer 31 is connected electrically to the diffusion zone 16. The upper film 22 of the displaceable member 4 is connected electrically with the response electrode 10 by a wiring layer 32, as shown in FIGS. 1 and 5. Thus, the response electrode 10 is connected electrically to the diffusion zone 16.

Likewise, a wiring layer 33 is formed on the leg 6, as shown in FIGS. 1, 3, and 4, that electrically connects the diffusion zone 17 with the upper film 22 of the displaceable member 8. The contact point 6a defines an opening through which the wiring layer 33 is connected electrically to the diffusion zone 17. The upper film 22 of the displaceable member 8 is connected electrically with one of the connecting posts 14 by a wiring layer 34, as shown in FIGS. 1, 4-6, and 8. Thus, the reference electrode 11 is connected electrically to the diffusion zone 17.

In a manner as discussed above, wiring layers 41-44 (corresponding with the wiring layers 31-34, respectively) make respective electrical connections with respect to the legs 3, 7 and the displaceable members 5, 9. Desirably, the material of the wiring layers 31-34, 41-44 is an electrically conductive material with a relatively low coefficient of thermal conductivity, such as titanium (Ti) or the like.

The radiation absorber 12 comprises a SiN layer of a desired thickness and that is reflective to a portion of the incident radiation i. Desirably, the reflectance of the radiation absorber 12 is about 33%. The radiation absorber 12 includes a planar portion 12a, that is roughly parallel with the substrate 1, and a side portion 12b extending along nearly the entire periphery of the planar portion 12a and extending roughly in the Z-axis direction toward the substrate 1. The side portion 12b optionally can be edged with an edge portion 12c that extends roughly parallel to the substrate slightly outward from the side portion 12b. The edge portion 12c can be omitted if desired. Since the planar portion 12a is reinforced structurally by the side portion 12b, the planar portion 12a can be made thinner than conventionally, without sacrificing the mechanical strength of the planar portion 12a.

The radiation absorber 12 is attached to the planar portion 10a of the response electrode 10 by connecting posts 19, one near each comer of the radiation absorber 12 (FIGS. 1 and 7). Thus, in this embodiment, the radiation absorber 12 is thermally coupled to the displaceable member 4 via the connecting posts 19 and the response electrode 10. The connecting posts 19 desirably comprise extensions (in the Z-direction) of the layer (e.g., SiN layer) comprising the radiation absorber 12.

The radiation absorber 12 is disposed so that the gap L1 between the radiation absorber 12 and the reference electrode 11 is substantially equal to nλ₀/4, wherein n is an odd number and λ is the center wavelength of the desired bandwidth of incident radiation i. For example, if λ₀ is 10 μm and n is 1, then the gap L1 is approximately 2.5 μm. In this embodiment, the reference electrode 11 also is used as a reflector that nearly completely reflects the incident radiation i. Hence, the radiation absorber 12 and the reference electrode 11 define an optical cavity therebetween.

The radiation detector according to the invention can be provided separately from the reference electrode 11. In addition, metal black or the like can be used as the radiation absorber instead of the type of radiation absorber 12 discussed above. The metal blacking can be formed on the lower surface of the response electrode 10, wherein incoming radiation is incident from the underside (as shown) of the substrate 1.

Although not illustrated in the figures, in a radiation detector according to this embodiment, the displaceable members 4, 5, 8, 9, the legs 2, 3, 6, 7, the response electrode 10, the reference electrode 11, and the radiation absorber 12 constitute a unit element (pixel). Normally, multiple pixels are arrayed one-dimensionally or two-dimensionally on the substrate 1. Also, although not illustrated, a “readout circuit” as known in the art can be formed on the substrate 1 that reads out the electrical capacitances between the diffusion zones 16, 17 of each pixel (i.e., the electrical capacitances between the electrodes 10, 11).

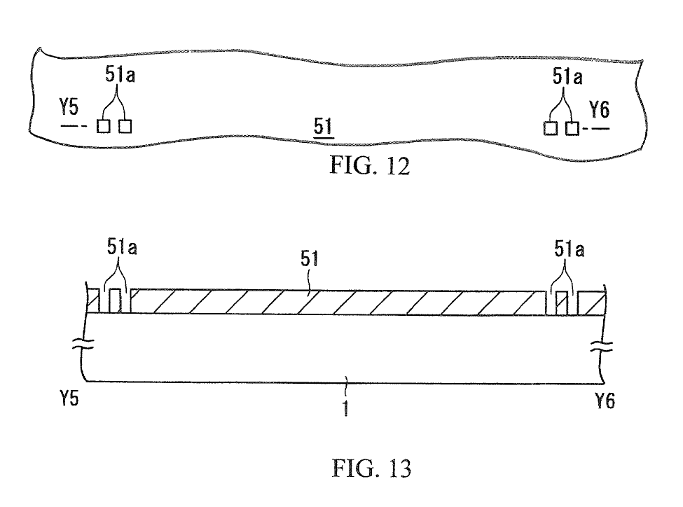

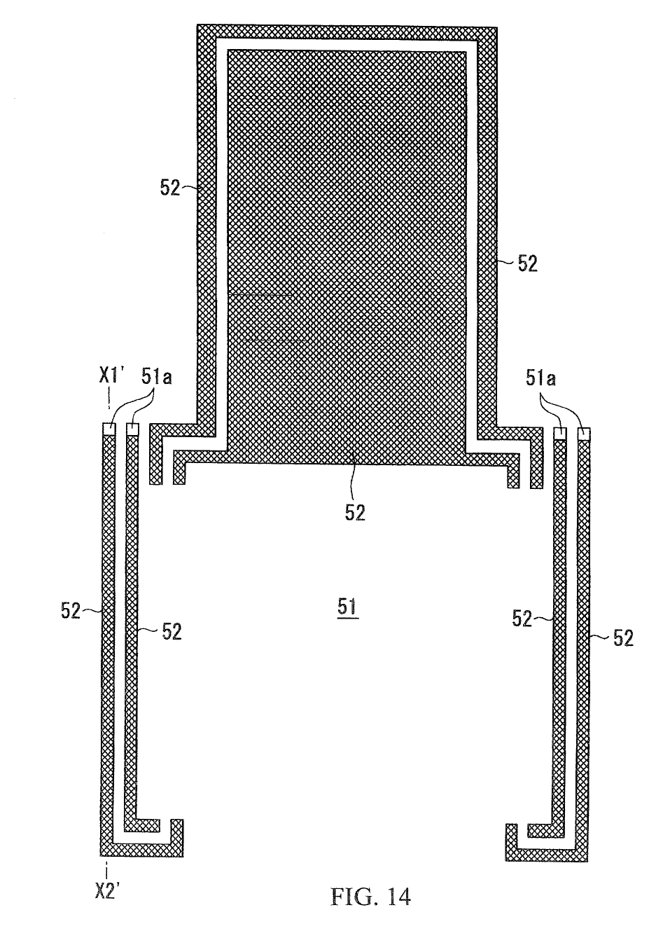

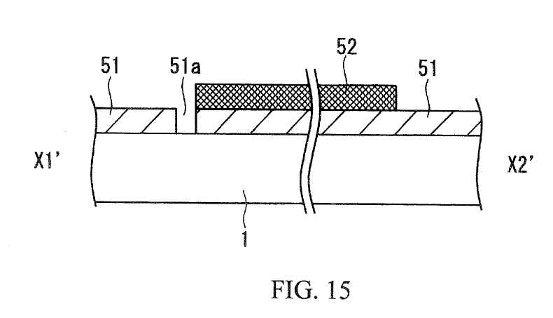

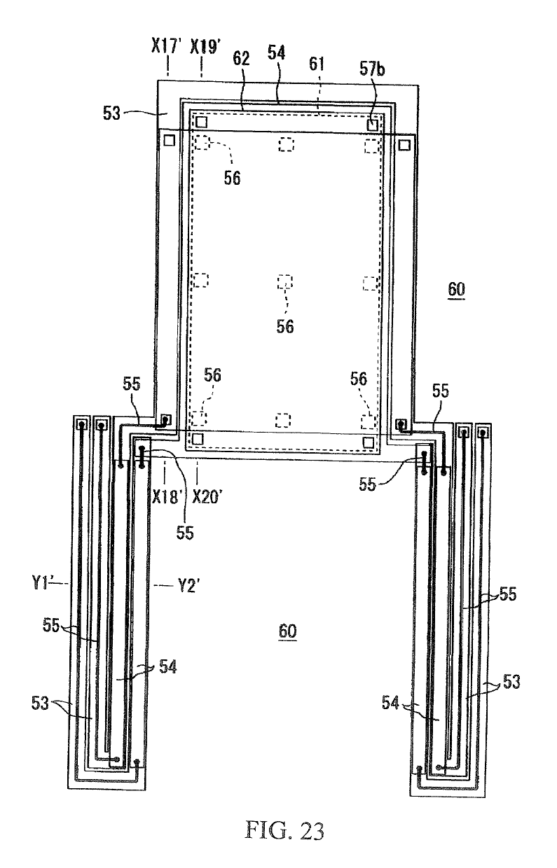

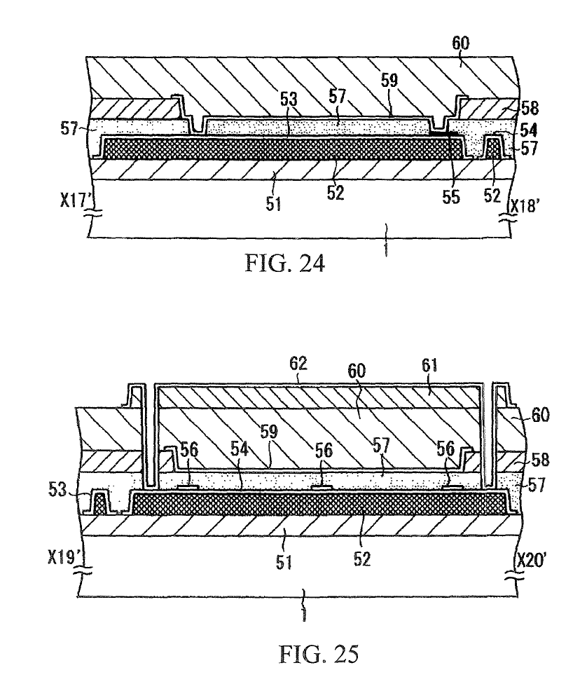

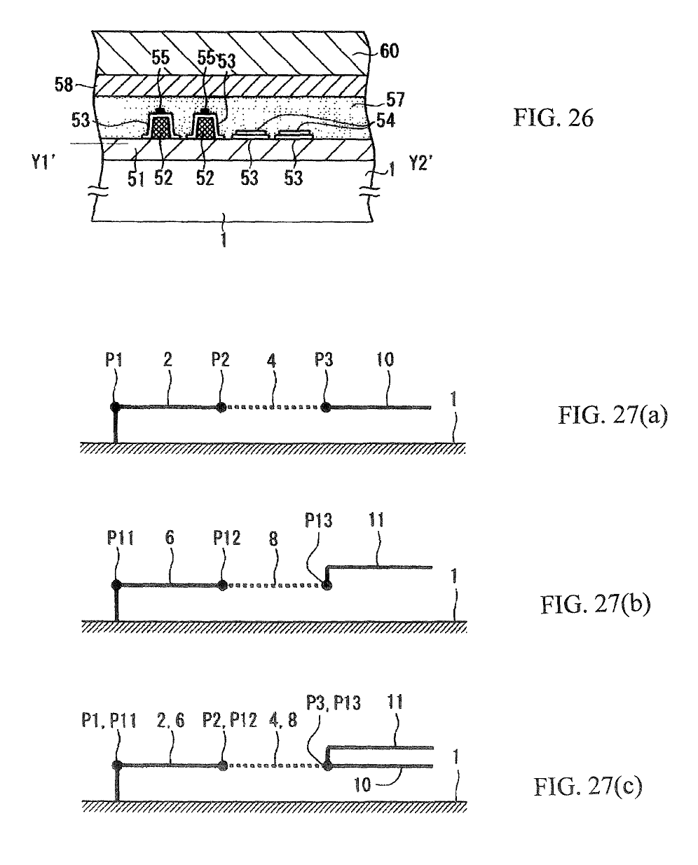

A representative method for fabricating a radiation detector according to this embodiment is described below with reference to FIGS. 12-26. FIGS. 12, 14, and 16-23 are respective schematic plan-view drawings illustrating the respective results of certain steps in the subject method. FIG. 13 is a schematic elevational section along the line Y5-Y6 in FIG. 12. FIG. 15 is a schematic elevational section along the line X1′-X2′ in FIG. 14. FIG. 24 is a schematic elevational section along the line X17′-X18′ in FIG. 23; FIG. 25 is a schematic elevational section along the line X19′-X20′ in FIG. 23; and FIG. 26 is a schematic elevational section along the line Y1′-Y2′ in FIG. 23. In each of these drawings, only one exemplary pixel (or portion thereof) is shown.

First, a silicon (Si) substrate 1 is prepared that includes the diffusion zones 16, 17 and optionally the readout circuit (not shown). A resist layer 51 is applied to the entire surface of the substrate 1. Using photolithography, openings 51a are formed in the resist 51 at locations corresponding to the contact points 2a, 6a for the respective legs 2, 6 and to contact points for the respective legs 3, 7 (FIGS. 12 and 13).

Next, the entire surface of the substrate, in the condition shown in FIGS. 12 and 13, is coated with a “sacrificial” (temporary) layer 52 of polyimide applied by spin coating or analogous procedure. As used herein, “sacrificial” and “temporary,” when used in the context of a layer, are synonymous and denote that the subject layer will be removed later. Meanwhile, the sacrificial layer serves as, e.g., a “spacer” layer that facilitates formation of other layers above and below having a desired spacing between them. Selected portions of the polyimide layer 52 (including portions situated over the openings 51a) are removed by photolithography and etching to leave “islands” of the polyimide layer 52 in regions corresponding to the planar portions of the legs 2, 3, 6, 7, the planar portion of the support frame 13, and the planar portion of the response electrode 10 (FIGS. 14 and 15).

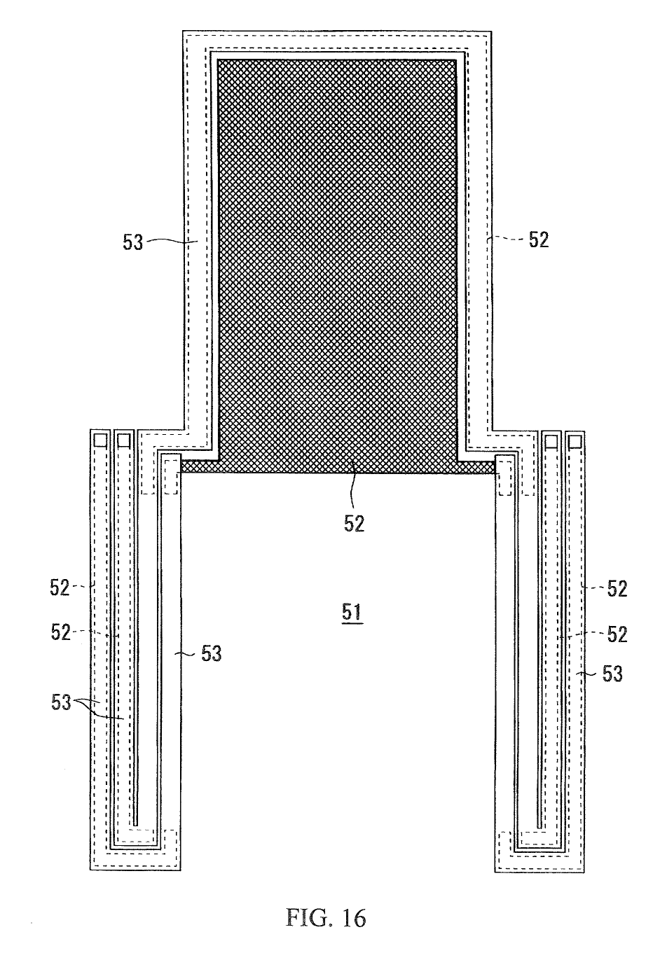

Next, a layer 53 of SiN (destined to be the support frame 13, the lower film 21 of each leg 2, 3, 6, 7, and the displaceable members 4, 5, 8, 9) is deposited by P-CVD or other suitable procedure. The SiN layer 53 is patterned by photolithography and etching in the intended respective profiles of the support frame 13, the lower film 21 of each leg 2, 3, 6, 7, and the displaceable members 4, 5, 8, 9 (FIG. 16). After the photolithographic patterning, the remaining portions of the SiN layer 53 used to define the respective features have dimensions that are slightly larger than corresponding dimensions of the underlying polyimide islands, thereby forming not only the planar portions of the respective features but also the side portions and edge portions of these features.

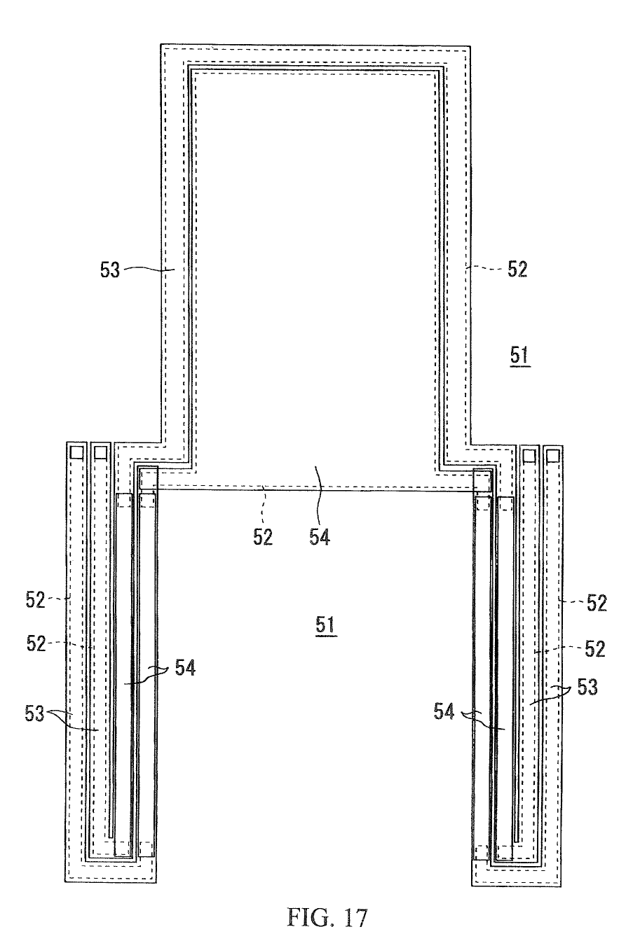

Next, over the SiN layer, a layer 54 of aluminum (Al) is applied that is destined to become the response electrode 10 and the “upper” films 22 of the displaceable members 4, 5, 8, 9. The Al layer 54 is deposited by vapor deposition or the like. The Al layer 54 is patterned by photolithography and etching to define the respective profiles of the response electrode 10 and the upper films 22 of the displaceable members 4, 5, 8, 9 (FIG. 17). After the photolithographic patterning, the remaining portion of the Al layer 54 used to define the response electrode 10 has dimensions that are slightly larger than corresponding dimensions of the underlying polyimide island, thereby forming not only the planar portion 10a of the response electrode but also the side portions 10b and edge portions 10c of this feature.

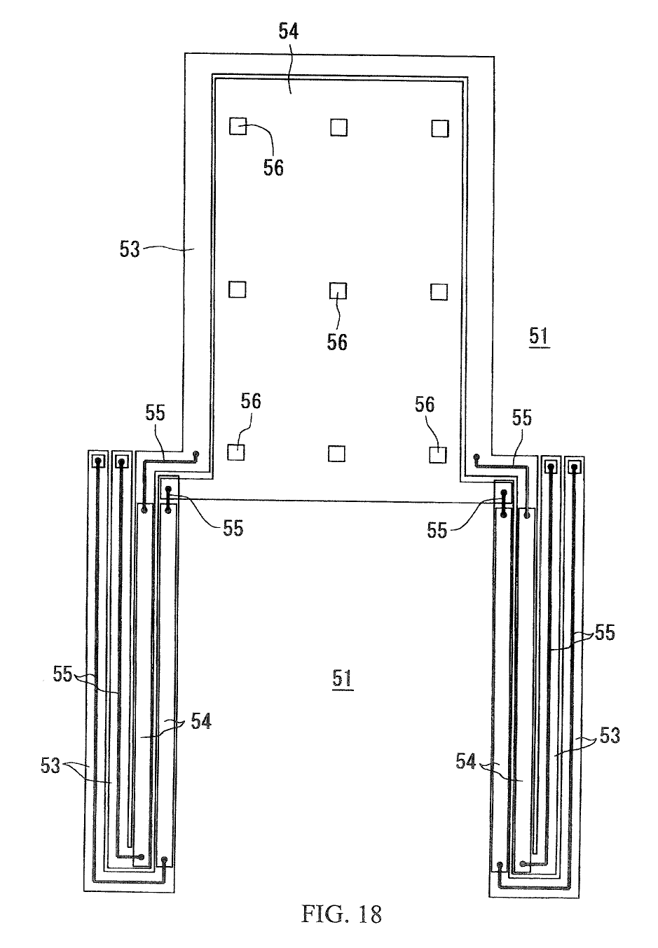

Next, openings destined to become respective connection openings for the wiring layers 31, 33, 41, 43 at the contact points 2a, 6a on the legs 2, 6 and the contact points on the legs 3, 7 are formed in the SiN film 53 by photolithography and etching. A titanium (Ti) layer 55, destined to become the wiring layers 31-34, and 41-44, is deposited by vapor deposition or the like. The Ti layer 55 is patterned by photolithography and etching in the intended shapes of the wiring layers 31-34 and 41-44. A layer 56 of SiN 56 (destined to become the insulator pads 15) is deposited by P-CVD or the like. The SiN layer 56 is patterned by photolithography and etching to form the insulator pads 15 (FIG. 18).

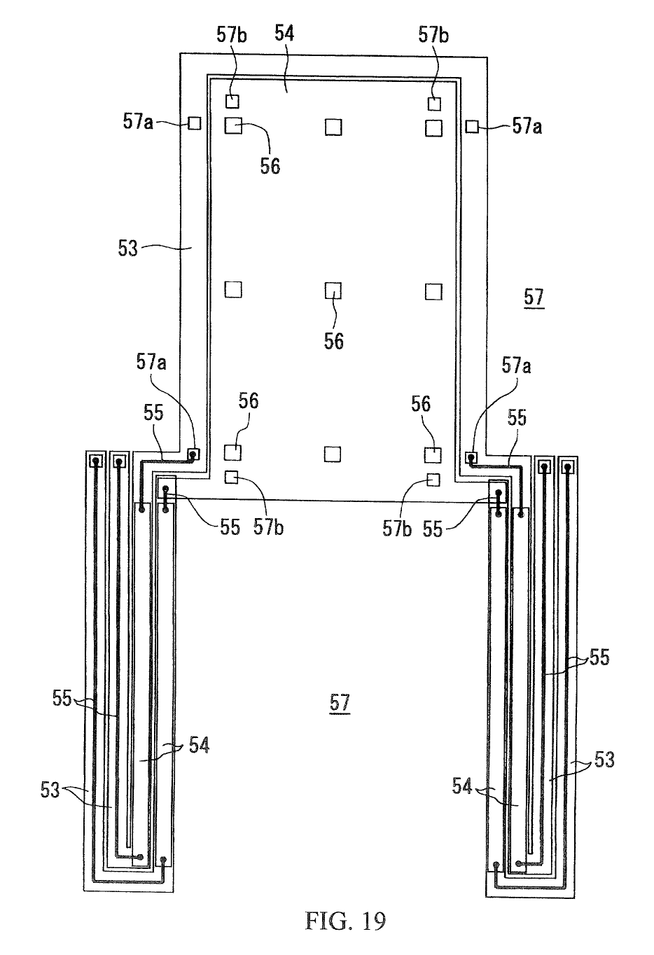

Next, the entire surface of the substrate, in the condition shown in FIG. 18, is coated with a sacrificial polyimide film 57 applied by spin coating or the like. Photolithography and etching are performed to form openings 57a, 57b in the polyimide film 57 (FIG. 19). The locations of the openings 57a, 57b correspond with the intended locations of the connecting posts 14, 19.

In FIG. 19, lines that otherwise would be obscured by overlying structure (and that normally would be indicated by dashed lines), e.g., lines obscured by the polyimide film 57, are denoted using solid lines. Actual structure is depicted in FIGS. 24-26, discussed below.

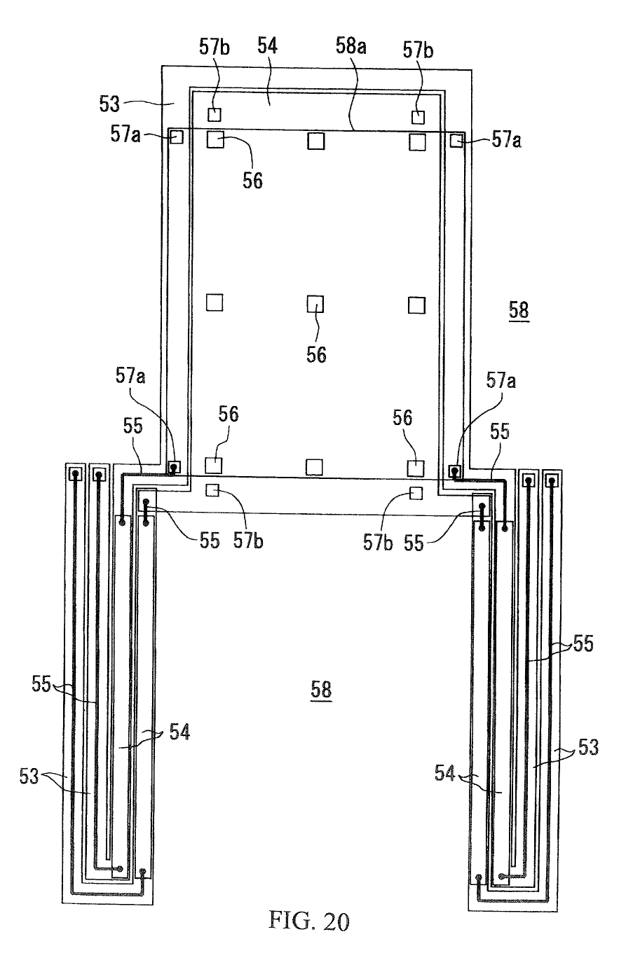

The entire surface of the substrate, in the condition shown in FIG. 19, is coated with a “temporary” layer of resist 58. An opening 58a is formed in the resist layer 58 by photolithography and etching, and the exposed polyimide is removed. The profile of the opening 58a corresponds to the profile of the planar portion 11a of the reference electrode 11. At the same time, openings 57a, 57b are formed in the resist layer 58 (FIG. 20).

In FIG. 20, lines that otherwise would be obscured by overlying structure (and that normally would be indicated by dashed lines), e.g., lines obscured by the resist layer 58, are denoted using solid lines. Actual structure is depicted in FIGS. 24-26, discussed below.

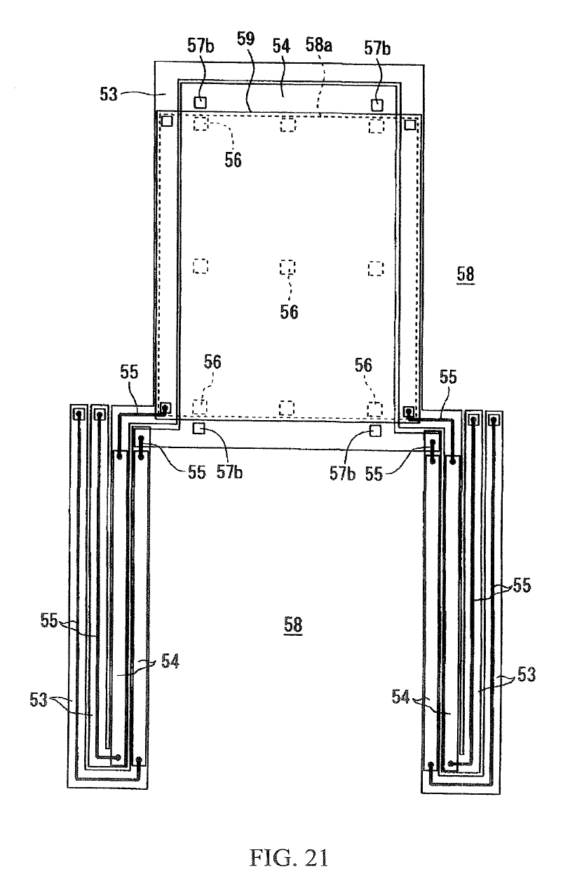

According to the patterned resist, a layer 59 of aluminum (Al), destined to become the reference electrode 11 and connecting posts 14, is deposited by vapor deposition or the like. The Al layer 59 is patterned by photolithography and etching in the respective shapes of the reference electrode 11 and connecting posts 14 (FIG. 21). After photolithographic patterning, the remaining portion of the Al layer 59 used to define the reference electrode 11 has dimensions that are slightly greater than corresponding dimensions of the opening 58a, thereby forming not only the planar portion of the reference electrode but also the side portions 11b and edge portions 11c of this feature.

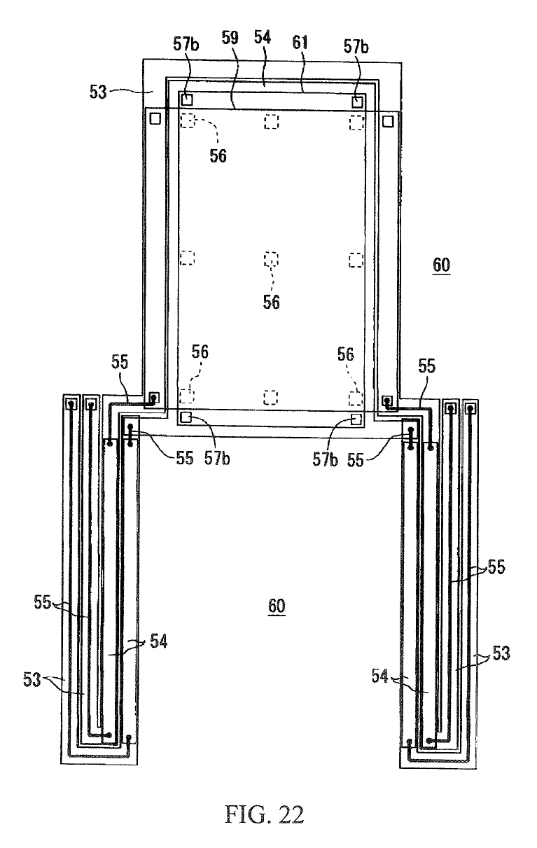

Next, the entire surface of the substrate, in the condition shown in FIG. 21, is coated with a sacrificial polyimide film 60 using spin coating or the like (FIG. 22). Polyimide film 60 that has entered the openings 57b is removed by photolithography and etching. The entire surface of the substrate, in this condition, is coated with a layer 61 of a resist. Subsequently, portions of the resist layer 61 (including resist in the area of the openings 57b) and underlying polyimide are removed by photolithography and etching to form islands 60 of polyimide and resist. One of the islands corresponds to the planar portion of the IR absorber 12.

Next, a layer 62 of SiN, destined to become the IR absorber 12 and connecting posts 19, is applied by P-CVD or the like. The SiN layer 62 is patterned by photolithography and etching to form the radiation absorber 12 having dimensions that are slightly greater than corresponding dimensions of the respective island of the polyimide film 60, thereby forming not only the planar portion 12a of the radiation absorber but also the side portions 12b and edge portions 12c of this feature, as well as the connecting posts 19.

The substrate in this condition is “diced” (cut) into individual “chips”, and all temporary layers of resist 51, 58, 61 and sacrificial polyimide films 52, 57, 60 are removed by ashing or the like. Thus, fabrication of the radiation detector is completed.

Whenever incident IR radiation i is incident from above on the radiation detector formed as described above (configured according to the first representative embodiment), some of the incident radiation i is absorbed by the radiation absorber 12. The remaining incident radiation is reflected by the reference electrode 11, serving as a radiation reflector, then reflected by the radiation absorber 12 so as to be incident again on the reference electrode 11. As a result, interference occurs in the gap between the radiation absorber 12 and the reference electrode 11. The magnitude of the gap L1 between the radiation absorber 12 and the reference electrode 11 is roughly an odd multiple of one-quarter of the central wavelength of the desired wavelength band of incident radiation i. Consequently, absorption of radiation by the radiation absorber 12 is nearly maximal, thereby increasing the efficiency of radiation absorption by the radiation absorber 12. Thus, the radiation-absorption efficiency of the radiation absorber 12 is increased even if the radiation absorber 12 is thinner than conventionally (a decrease in thickness tends to reduce the thermal capacity of the radiation absorber 12). As a result, both detection sensitivity and detection responsiveness of the radiation detector is increased.

Heat generated in the radiation absorber 12 by absorption of incident radiation is transmitted to the displaceable members 4, 5 via the connecting post 19. The transmitted heat causes the cantilevered displaceable members 4, 5 to bend downward in this embodiment. The resulting tilt of the response electrode 10 corresponds to the amount of incident radiation i absorbed by the radiation absorber 12. The heat generated in the radiation absorber 12 is not transmitted to the displaceable members 8, 9. Consequently, the displaceable members 8, 9 do not bend, and the change in the gap distance between the response electrode 10 and the reference electrode 11 corresponds only to the amount of incident radiation i absorbed. The change in distance between the response electrode 10 and the reference electrode 11 causes a corresponding change in the electrical capacitance between these two electrodes, allowing the incident radiation to be detected as a corresponding change in electrical capacitance, as measured across the diffusion layers 16, 17. The diffusion layers 16, 17 are connected to a read-out circuit (not shown but well understood in the art) that reads out the electrical capacitance across them. The unit pixels of the radiation detector are arranged in a one-dimensional or two-dimensional array, so that an image signal, based on respective amounts of incident radiation absorbed by the unit pixels, can be obtained from the read-out circuit.

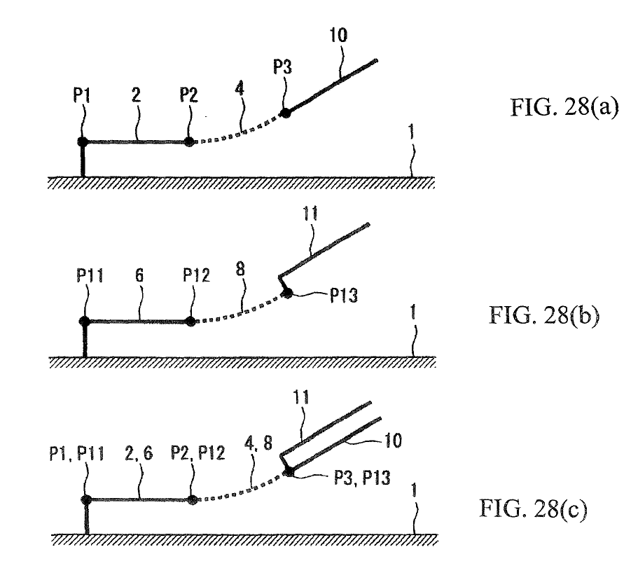

In this embodiment, the first displaceable members 4, 5 and second displaceable members 8, 9 are disposed so as not to be layered over or under one another when viewed from a layering direction (i.e., Z-direction). This allows the respective “lower” films 21 of the first displaceable members 4, 5 and the respective “lower” films 21 of the second displaceable members 8, 9 to be formed simultaneously, and the respective “upper” films 22 of the first displaceable members 4, 5 and the respective “upper” films 22 of the second displaceable members 8, 9 to be formed simultaneously (FIG. 16). As a result, even if the first displaceable members 4, 5 and/or second displaceable members 8, 9 are warped by stress encountered during fabrication of the layers 21, 22, (1) the warping conditions are substantially the same in the first displaceable members 4, 5 as in the second displaceable members 8, 9, and (2) the gap (or other positional relationship) between the reference electrode 11 and the response electrode 10 always can be set to the desired distance (or other positional relationship). These characteristics greatly increase the success rate of achieving a desired radiation-detection sensitivity and desired dynamic range of radiation detection, compared to conventional devices. This point is discussed below, referring to FIGS. 27(a)-27(c) and 28(a)-28(c).

In the following discussion, the (X, Z) position (as viewed from the Y-axis direction) of the “start” point P1 of the leg 2 (FIG. 2) matches the (X, Z) position of the “start” point P11 of the leg 6 (FIG. 3). Also, the (X, Z) position of the “end” point P2 of the leg 2 (FIG. 5), which is the same as the “start” point of the displaceable member 4, is the same as the (X, Z) position of the “end” point P12 of the leg 6 (FIG. 4), which is the same as the “start” point of the displaceable member 8. Consequently, the distance in the length direction (as viewed in the Y-direction) of the leg 2 from its start point P1 to its end point P2 is equal to the distance in the length direction (as viewed in the Y-direction) of the leg 6 from its start point P11 to its end point P12. In addition, the length of the displaceable member 4 from its start point P2 to its end point P3 (FIG. 5) is equal to the length of the displaceable member 8 from its start point P12 to its end point P13 (FIG. 4). These respective relationships are similar for the legs 3, 7 and the displaceable members 5, 9.

FIGS. 27(a)-27(c) show a modeled example of an initial condition of the radiation detector of this embodiment (i.e., a condition in which no radiation i is incident on the detector), taking into consideration the points described above. FIG. 27(a) is a simplified rendering of the leg 2, the displaceable member 4, and the response electrode 10 as viewed from the Y-axis direction. FIG. 27(b) is a simplified rendering of the leg 6, the displaceable member 8, and the reference electrode 11 as viewed from the Y-axis direction. FIG. 27(c) is a simplified rendering of both legs 2, 6, both displaceable members 4, 8, and both electrodes 10, 11, as viewed from the Y-axis direction. I.e., FIG. 27(c) is essentially an overlay of FIGS. 27(a) and 27(b). Whereas the legs 2, 6 in this embodiment are disposed so as to double-back on the displaceable members 4, 8, as shown in FIG. 1, the legs 2, 6 are depicted in FIGS. 27(a)-27(c) as extending straight from the displaceable members 4, 8. Also, in FIGS. 27(a)-27(c), the legs 2, 6 extend parallel to the substrate 1, and the displaceable members 4, 8 initially are parallel to the substrate 1.

FIGS. 28(a)-28(c) depict another modeled example of an “initial” condition of the radiation detector of this embodiment. FIGS. 28(a)-28(c) correspond to FIGS. 27(a)-27(c), respectively. In FIGS. 28(a)-28(c), a condition is shown in which the displaceable members 4, 8 are bent initially upward due to stress encountered during formation of the films 21, 22 constituting the thermal bimorph structure of the displaceable members 4, 8. Since the displaceable members 4, 8 are manufactured at the same time, as discussed above, the initial bent conditions of both displaceable members 4, 8 are identical.

As can be seen from comparing FIGS. 27(a)-27(c) with FIGS. 28(a)-28(c), even if the displaceable members 4, 8 are initially bent from stress encountered during formation of the films 21, 22, the “initial” gap between the reference electrode 11 and the response electrode 10 remains the same as when the displaceable members 4, 8 initially have no stress. This means that the initial gap between the reference electrode 11 and the response electrode 10 always can be established and maintained (within an acceptable tolerance) to a desired distance even if the displaceable members 4, 8 are initially bent due to stress encountered during formation of the films 21, 22. Therefore, desired radiation-detection sensitivity and dynamic range of radiation detection can be obtained with this embodiment. In addition, variances in the respective initial positional relationships of the reference electrode 11 and response electrode 10 from one pixel to another of the radiation detector can be ameliorated with this embodiment.

Since the reference electrode 11 is attached to the second displaceable members 8, 9 (that are structured identically to the first displaceable members 4, 5 in this embodiment), even if the first displaceable members 4, 5 are deformed by a change in ambient temperature, the second displaceable members 8, 9 are deformed similarly. Consequently, the relative positional relationship of the reference electrode 11 to the response electrode 10 is unchanged by changes in ambient temperature. As a result, IR radiation i from an object can be detected with good accuracy without the electrical capacitance between the electrodes 10, 11 changing or being affected by ambient temperature. Although the temperature of the substrate can be controlled so as to be unaffected by changes in ambient temperature, such strict temperature control is not required, allowing for reduced cost of operation of the radiation detector.

Since the first displaceable members 4, 5 and second displaceable members 8, 9 are manufactured in the same manufacturing steps in this embodiment, as discussed above, differences in film characteristics (e.g., film thickness, etc.) of the first displaceable members 4, 5 and the second displaceable members 8, 9 essentially are eliminated. This offsets the differences in deflection characteristics of the first displaceable members 4, 5 and the second displaceable members 8, 9, observed with conventional radiation detectors. Hence, with a radiation detector made according to this embodiment, whenever strict temperature control of the substrate 1 is not being performed, changes in electrical capacitance between the electrodes 10, 11 due to changes in ambient temperature are decreased compared to conventional radiation detectors, yielding improved detection accuracy and precision compared to conventional radiation detectors.

Naturally, when using a radiation detector according to this and the first representative embodiments, any effects of changes in ambient temperature can be avoided by placing the radiation detector inside a vacuum chamber or by strictly controlling the temperature of the substrate.

In this embodiment, the radiation absorber 12, reference electrode 11, and response electrode 10 in a radiation detector are disposed (in a direction in which the films 21, 22 are layered, or Z-axis direction) in the stated order from the substrate 1, as shown in FIG. 11. The first displaceable member 4 is configured so as to move, as its temperature increases, the response electrode 10 away from the reference electrode 11 (i.e., the direction of the arrow in FIG. 11). Consequently, the electrical capacitance between the electrodes 10, 11 changes inversely proportionally to the distance between the electrodes 10, 11.

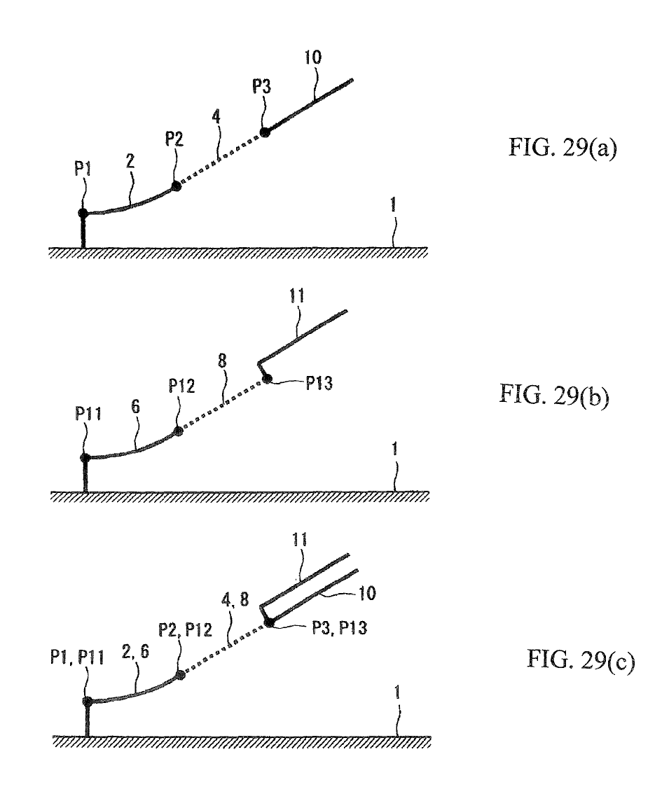

FIGS. 29(a)-29(c), corresponding with FIGS. 27(a)-27(c), respectively, depict yet another modeled example of an initial condition of the radiation detector of this embodiment. In this embodiment, the length of the leg 2 from its start point P1 to its end point P2 is equal to the length of the leg 6 from its start point P11 to its end point P12, as discussed above. Such a configuration is desired because the heights and angles, relative to the substrate 1, of the first and second legs 2, 6 at their respective end points P2, P12 are mutually equal even if the first and second legs 2, 6 are deflected initially due to stress encountered during formation of their respective films, as shown in FIGS. 29(a)-29(c).

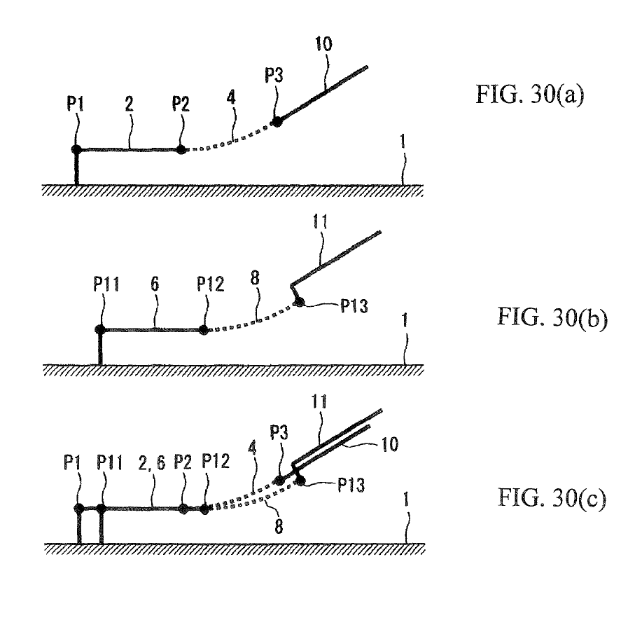

This initial condition can be modified as shown in FIGS. 30(a)-30(c), which show a modeled example of an initial condition of a modified radiation detector of this embodiment. FIGS. 30(a)-30(c) correspond to FIGS. 28(a)-28(c), respectively. In the situation shown in FIGS. 28(a)-28(c), the gap between the electrodes 10, 11 is equal to the thickness of the sacrificial polyimide layer 57 in FIGS. 24 and 25, and cannot be made thinner than the thickness of the layer 57. In contrast, in the situation shown in FIGS. 30(a)-30(c), the (X, Z) position of the start point P2 of the first leg 2 and the (X, Z) position of the start point P12 of the second leg 6 are shifted so as to narrow the gap between the electrodes. I.e., the gap between the electrodes 10, 11 is made narrower than the thickness of the layer 57, thereby increasing the IR-detection sensitivity.

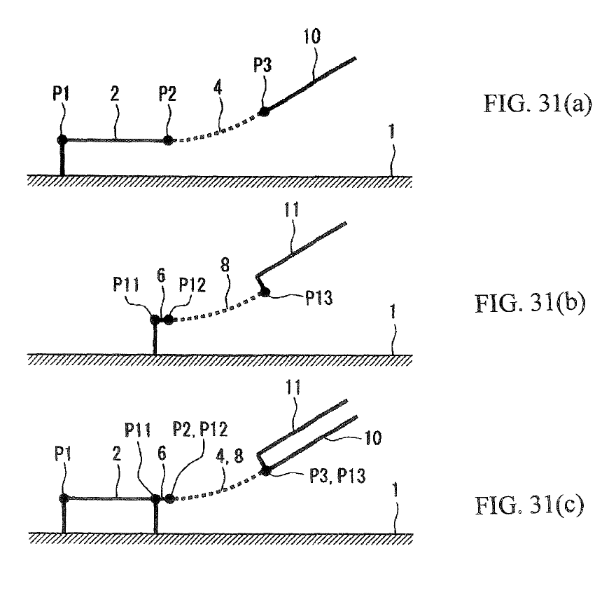

This embodiment can be modified further as shown in FIGS. 31 (a)-31(c), showing a modeled example of an initial condition of the modified embodiment. FIGS. 31(a)-31(c) correspond to FIGS. 28(a)-28(c), respectively. Whenever the legs 2, 6 are parallel to the substrate 1, as in the case of FIG. 28(a), the same performance can be obtained even if the length of the leg 6 were essentially zero, as shown in FIG. 31(a). It is not desirable to make the length of the leg 2 equal to zero because such a configuration would make it easier for heat generated in the IR absorber 12 and transmitted to the displaceable member 4 to escape to the substrate 1. However, this problem would not arise if the leg 6 had essentially zero length. Making the length of the leg 6 essentially equal to zero, as shown in FIGS. 31(a)-31(c), is desirable because it reduces the space occupied by the second leg 6 on the substrate.

### Second Representative Embodiment

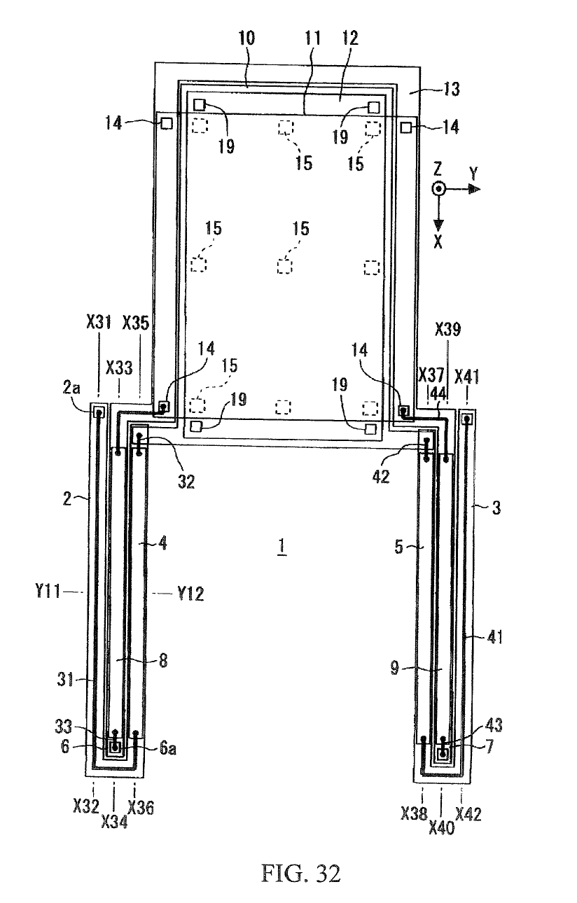

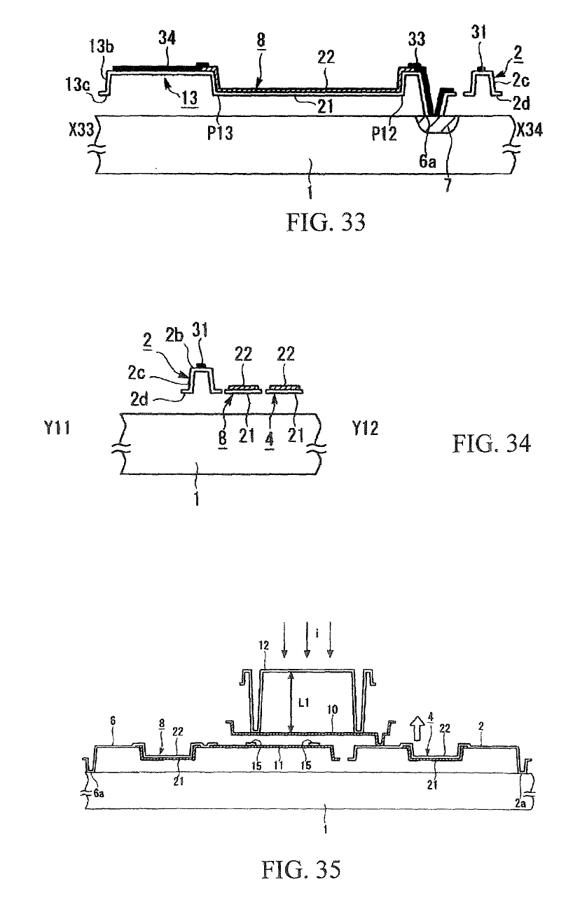

FIG. 32 is a schematic plan view of a unit “pixel” (unit element) of a radiation detector according to this embodiment. FIG. 33 is a schematic elevational section along the line X33-X34 in FIG. 32, and FIG. 34 is a schematic elevational section along the line Y11-Y12 in FIG. 32. In these figures, elements that are identical to or that correspond with respective elements in FIGS. 1-11 have the same respective reference numerals and are not described further below.

Although not included in the figures, respective schematic elevational sections along the lines X31-X32 and X41-X42 in FIG. 32 would be similar to FIG. 2, and respective schematic elevational sections along the lines X35-X36 and X37-X38 would be similar to FIG. 5. Also, respective schematic elevational sections along the lines X33-X34 and X39-X40 in FIG. 32 are similar (FIG. 33).

This embodiment differs from the first representative embodiment in that the legs 6, 7 have a length of zero in the second representative embodiment. Consequently, the legs 2, 3 are disposed immediately adjacent, lengthwise, to the respective displaceable members 8, 9. By thus effectively eliminating the legs 6, 7, the width (in the Y-direction) of the pixel depicted in FIG. 32 is narrower than the pixel depicted in FIG. 1.

### Third Representative Embodiment

FIG. 35 is a schematic elevational section of a unit pixel of a radiation detector according to this embodiment. The section shown in FIG. 35 corresponds to the section shown in FIG. 11. In FIG. 35, elements that are identical to or that correspond to respective elements shown in FIGS. 1-11 have the same respective reference numerals and are not described further below.

This embodiment differs from the first representative embodiment as follows. First, in this embodiment, the reference electrode 11 is closer (in the Z-direction) to the substrate 1 than the response electrode 10; in the first representative embodiment, the response electrode 10 is closer (in the Z-direction) to the substrate 1 than the reference electrode 11. In other words, in this embodiment, the stacking order (in the Z-direction, from the surface of the substrate 1) of the response electrode 10 and reference electrode 11 is reversed from that of the first representative embodiment. Second, in this embodiment, the “lower” films 21 of the displaceable members 4, 5, 8, 9 are Al films, and the “upper” films 22 are SiN films (in the first representative embodiment, in contrast, the lower films 21 are Al and the upper films 21 are SiN). Hence, in this embodiment, the first displaceable members 4, 5 when heated deflect so as to move the response electrode 10 away from, rather than toward, the reference electrode 11 (in the direction indicated by the large open arrow in FIG. 35). In addition, in this embodiment, the response electrode 10 is used also as a radiation reflector that almost totally reflects incident radiation i. Consequently, the radiation absorber 12 and response electrode 10 define an optical cavity therebetween.

Notwithstanding the differences between the first and third representative embodiments, as discussed above, the third representative embodiment provides the same advantages as provided by the first representative embodiment.

### Fourth Representative Embodiment

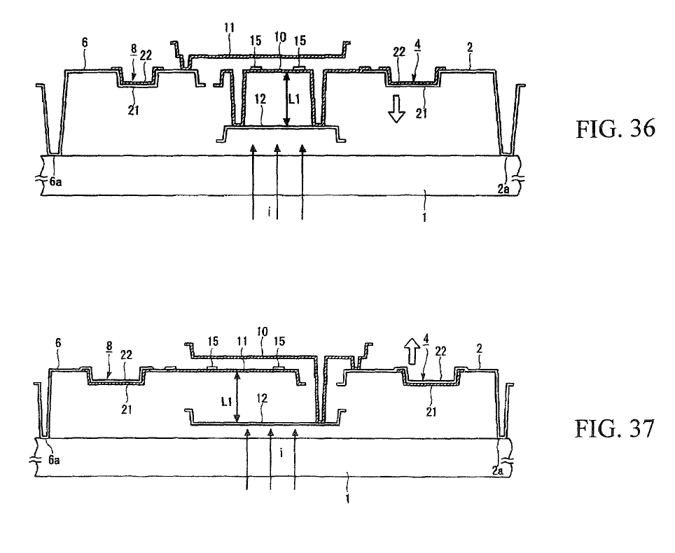

FIG. 36 is a schematic elevational section of a unit pixel of a radiation detector according to this embodiment. The section shown in FIG. 36 corresponds to the section shown in FIG. 11. In FIG. 36, elements that are identical to or that correspond with respective elements shown in FIGS. 1-11 have the same respective reference numerals and are not described further below.

This embodiment differs from the first representative embodiment as follows. First, in this embodiment, the radiation absorber 12 is closest (in the Z-direction) to the substrate 1, and the response electrode 10 is situated between the radiation absorber 12 and the reference electrode 11. In other words, the stacking order (in the Z-direction, from the surface of the substrate 1) is first the radiation absorber 12, then the response electrode 10, and finally the reference electrode 11. Also, in this embodiment, the “lower” films 21 in the displaceable members 4, 5, 8, 9 are made of SiN, and the “upper” films 22 are made of Al. Hence, when heated, the first displaceable members 4, 5 deflect to as to move the response electrode 10 away from the reference electrode 11 (in the direction of the large open arrow in FIG. 36). In addition, in this embodiment, the response electrode 10 serves also as a reflector that almost totally reflects incident radiation i. As a result, the radiation absorber 12 and the response electrode 10 define an optical cavity therebetween. Finally, in this embodiment, the incident radiation i passes through the substrate 1 before impinging on the radiation absorber 12.

Notwithstanding the differences between the first and fourth representative embodiments, as discussed above, the fourth representative embodiment provides the same advantages as provided by the first representative embodiment.

### Fifth Representative Embodiment

FIG. 37 is a schematic elevational section of a unit pixel of a radiation detector according to this embodiment. The section shown in FIG. 37 corresponds to the section shown in FIG. 11. In FIG. 37, elements that are identical to or that correspond with respective elements shown in FIGS. 1-11 have the same respective reference numerals and are not described further below.

This embodiment differs from the first representative embodiment as follows. First, in this embodiment, the radiation absorber 12 is closest (in the Z-direction) to the substrate 1, and the reference electrode 11 is situated between the radiation absorber 12 and the response electrode 10. In other words, the stacking order (in the Z-direction, from the surface of the substrate 1) is first the radiation absorber 12, then the reference electrode 11, and finally the response electrode 10. Also, in this embodiment, the “lower” films 21 of the displaceable members 4, 5, 8, 9 are made of Al, and the “upper” films 22 are made of SiN. Hence, when heated, the first displaceable members 4, 5 deflect so as to move the response electrode 10 away from the reference electrode 11 (in the direction indicated by the large open arrow in FIG. 37). In addition, the reference electrode 11 in this embodiment serves also as a reflector that almost totally reflects incident radiation i. As a result, the radiation absorber 12 and reference electrode 11 define an optical cavity therebetween. Finally, in this embodiment, the incident radiation i passes through the substrate 1 before impinging on the radiation absorber 12.

Notwithstanding the differences between the first and fifth representative embodiments, as discussed above, the fifth representative embodiment provides the same advantages as provided by the first representative embodiment.

### Sixth Representative Embodiment

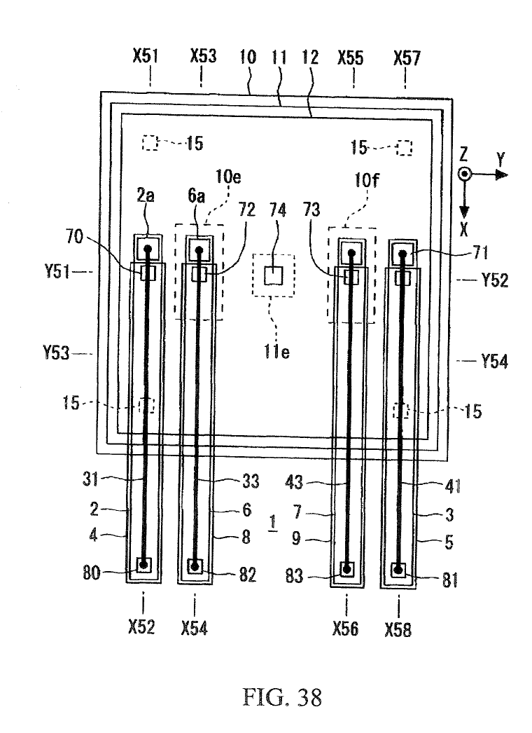

A plan view of a unit pixel of a radiation detector according to this embodiment is shown in FIG. 38. In FIG. 38 hidden lines (that otherwise would be denoted by respective broken lines) are denoted by solid lines, and lines that otherwise would indicate a difference in height (from the plane of the page) are omitted. Mutually orthogonal X-, Y-, and Z-axes are as shown in FIG. 38.

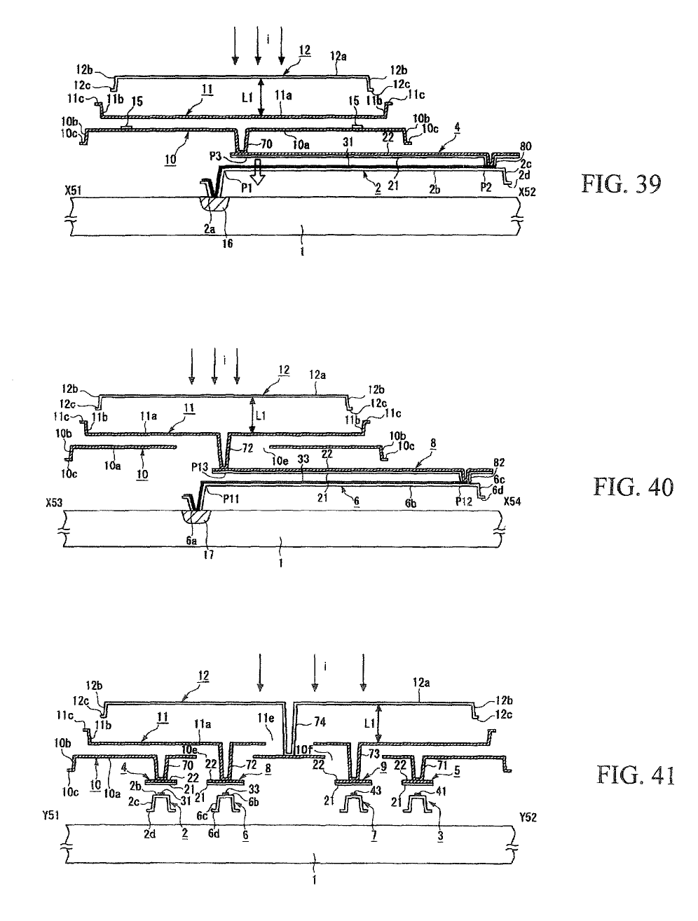

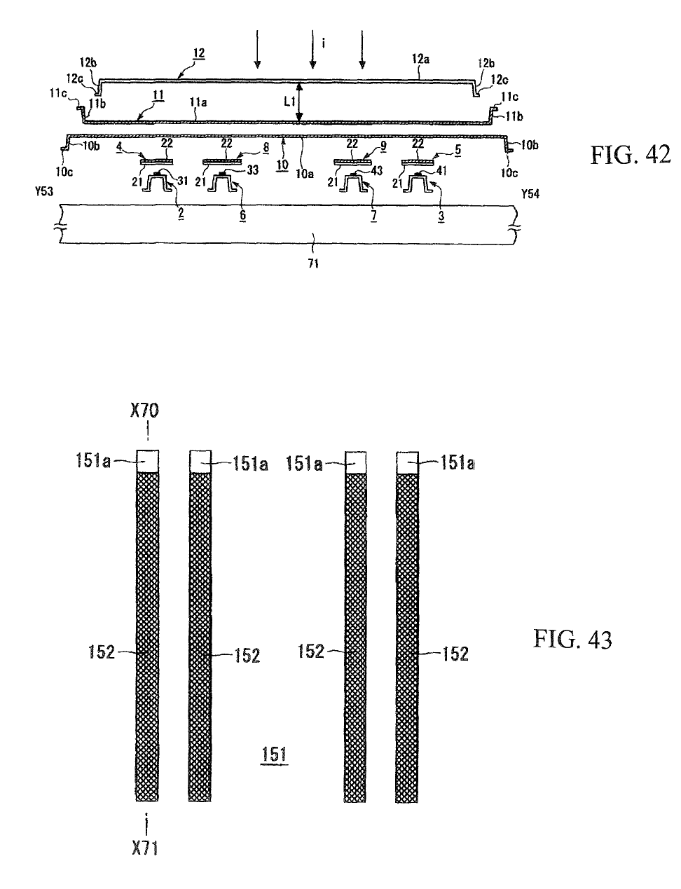

With respect to FIG. 38, FIG. 39 is a schematic elevational section along the line X51-X52, FIG. 40 is a schematic elevational section along the line X53-X54, FIG. 41 is a schematic elevational section along the line Y51-Y52, and FIG. 42 is a schematic elevational section along the line Y53-Y54. Although not shown in the figures, a schematic elevational section along the line X55-X56 in FIG. 38 would be similar to FIG. 40, and a schematic elevational section along the line X57-X58 in FIG. 38 would be similar to FIG. 39. In these figures, elements that are identical to or correspond with respective elements in FIGS. 1-11 have the same respective reference designators and are not described further below. Rather, the following description is directed to the significant differences of this embodiment from the first representative embodiment.

Whereas the legs 2, 3, 6, 7 and respective displaceable members 4, 5, 8, 9 in the first representative embodiment are situated laterally beside each other (see FIG. 1), the displaceable members 4, 5, 8, 9 in the sixth representative embodiment are situated directly “above” (in the “stacking direction” or Z-direction) respective legs 2, 3, 6, 7, with respective gaps between displaceable members and respective legs.

Hence, in this embodiment, the displaceable members 4, 5, 8, 9, the response electrode 10, the reference electrode 11, and the radiation absorber 12 have a different scheme of interconnection than in the first representative embodiment. Namely, in this embodiment, the displaceable members 4, 5, 8, 9 are attached to respective legs 2, 3, 6, 7 by respective connectors 80, 81, 82, 83 formed by extensions of the “upper” film (Al) 22 and “lower” film (SiN) 21 of the respective displaceable members 4, 5, 8, 9 (FIGS. 39 and 40). As discussed below, all the upper films 22 and lower films 21 are formed simultaneously during respective fabrication steps. The upper film 22 at the connection to the respective legs 2, 3, 6, 7 at the respective connectors 80, 81, 82, 83 are configured to connect to respective wiring layers 31, 41, 33, 43 (FIGS. 39 and 40).

The response electrode 10 is attached to “free” ends of the displaceable members 4, 5 by respective connectors 70, 71 formed by extensions of the upper (Al) film 22 constituting the respective displaceable members (FIG. 39). The reference electrode 11 is attached to “free” ends of the displaceable members 8, 9 by respective connectors 72, 73 formed by extensions of the upper (Al) film 22 constituting the respective displaceable members (FIG. 40). Openings 10e, 10f are defined in the response electrode 10 through which the respective connectors 72, 73 extend (FIGS. 38 and 40). The radiation absorber 12 is attached to the center of the response electrode 10 by a connector 74 formed by an extension of the SiN film constituting the radiation absorber 12 (FIG. 41). An opening 11e is defined in the reference electrode 11 through which the connector 74 extends (FIGS. 38 and 41).

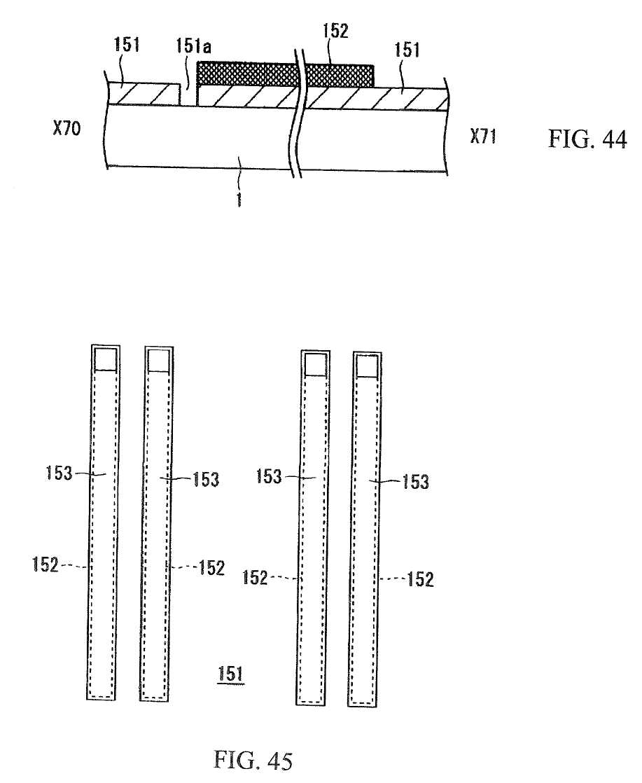

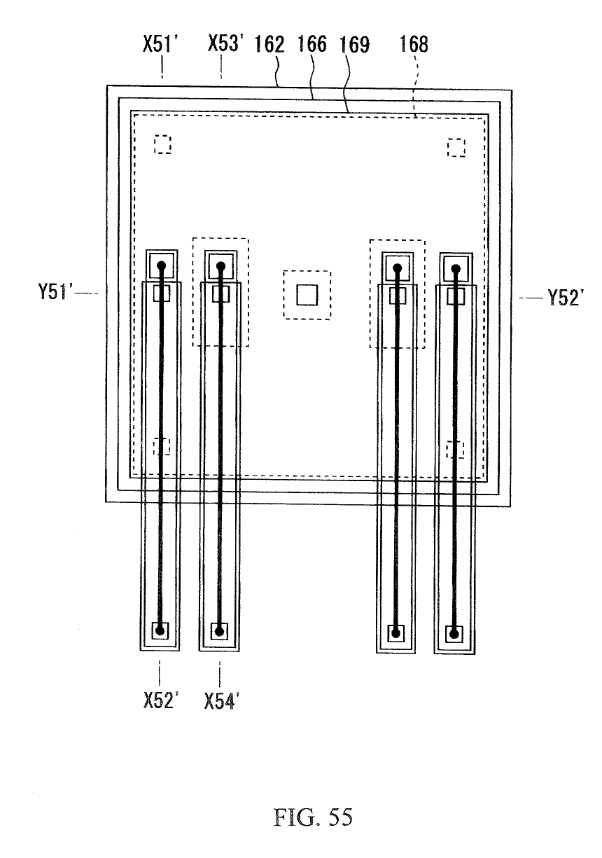

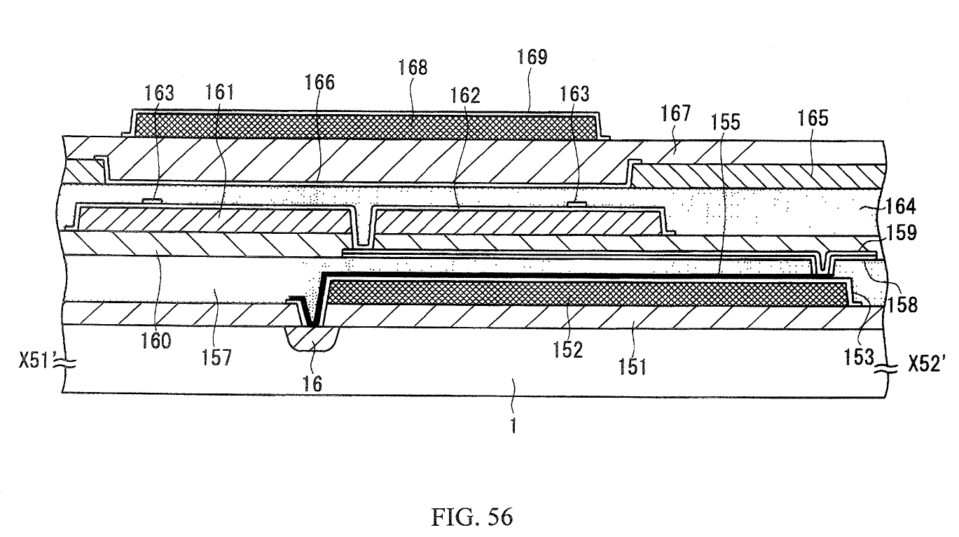

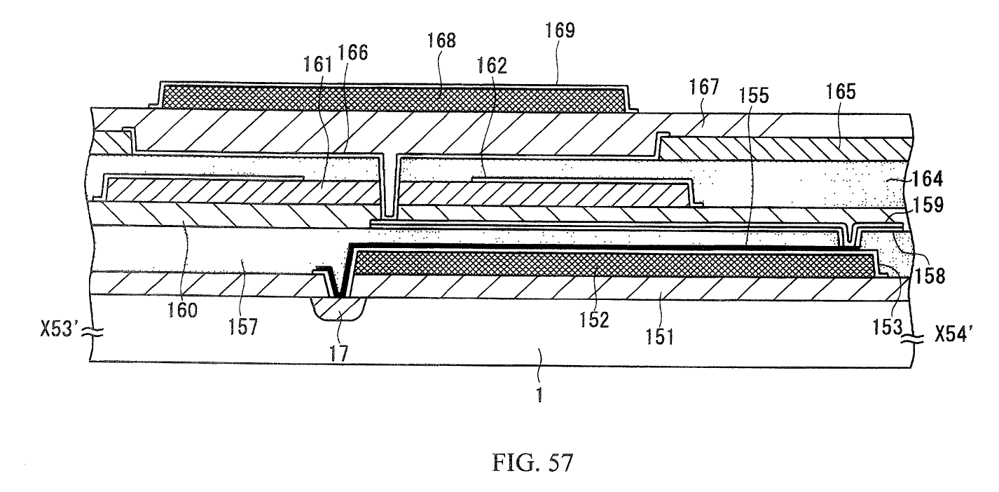

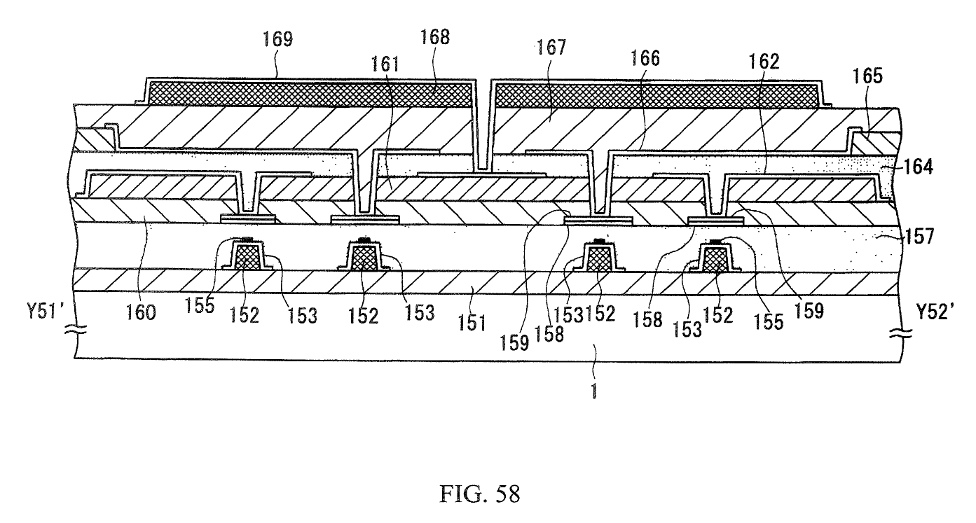

An exemplary method for manufacturing the radiation detector of this embodiment is described below with reference to FIGS. 43-58. FIGS. 43 and 45-55 are respective schematic plan views illustrating the results of respective steps in the method. FIG. 44 is a schematic elevational section along the line X70-X71 in FIG. 43. With respect to FIG. 55, FIG. 56 is a schematic sectional drawing along the line X51′-X52′, FIG. 57 is a schematic elevational section along the line X53′-X54′, and FIG. 58 is a schematic elevational section along the line Y51′-Y52′. In these drawings, only one exemplary pixel is shown.

In a first step, a silicon (Si) substrate 1 is prepared in which diffusion layers 16, 17 and a readout circuit (not shown) have been formed. A “temporary” resist layer 151 is applied to the entire surface of the substrate 1. By photolithography, openings 151 a are formed in the resist 151 at locations that correspond to respective locations of the contact points 2a, 6a for the legs 2, 6, respectively, as well as respective contact points for the legs 3, 7. Next, the entire surface of the substrate, in the condition shown in FIG. 43, is coated with a sacrificial polyimide film 152 applied by spin coating or the like. Portions of the polyimide film 152 (including polyimide film deposited over the openings 151a) are removed by photolithography and etching, leaving islands of polyimide film 152 in regions corresponding to the planar portions of the legs 2, 3, 6, 7 (FIGS. 43 and 44).

Next, a layer 153 of SiN, destined to become the legs 2, 3, 6, 7, is deposited by P-CVD or the like. The SiN layer 153 is patterned by photolithography and etching to define the respective profiles of the legs 2, 3, 6, 7 (FIG. 45). To form side portions and (optionally) edge portions, in addition to the planar portions of the legs, the regions of the SiN layer 153 left after patterning are slightly larger than the respective polyimide islands 152.

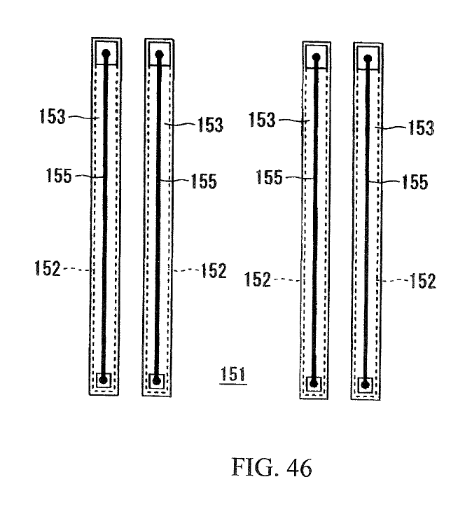

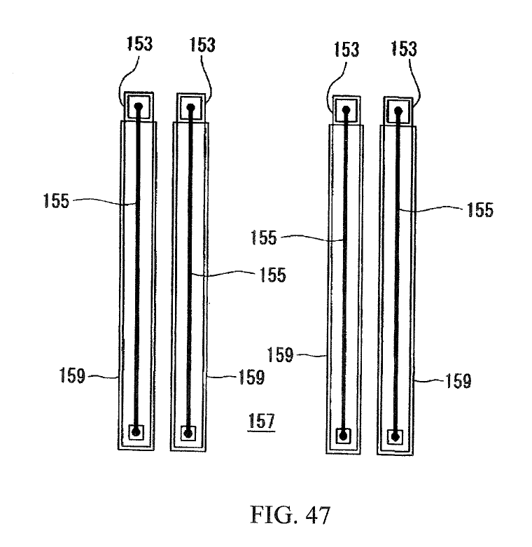

Next, openings are formed, by photolithography and etching, in the SiN layer 153 that are destined to become respective connection openings for the wiring layers 31, 33, 41, 43. These openings are formed at the contact points 2a, 6a on the legs 2, 6, respectively, and at contact points on the legs 3, 7 by photolithography and etching. A layer 155 of titanium (Ti), destined to become the wiring layers 31, 33, 41, 43, is deposited by vapor deposition or the like. The titanium layer 155 is patterned by photolithography and etching in the desired respective profiles of the wiring layers 31, 33, 41, 43 (FIG. 46). The entire surface of the substrate, in the condition shown in FIG. 46, is coated with a sacrificial polyimide film 157 applied by spin coating or the like. Openings are formed, by photolithography and etching, in the polyimide film 157 at respective locations corresponding to the respective locations of the connectors 80-83 are formed in the polyimide film 157. Next, a layer 158 of SiN, destined to become the “lower” film 21 of the displaceable members 4, 5, 8, 9 and the connectors 80-83, is deposited by P-CVD or the like. The SiN layer 158 is patterned by photolithography and etching to the desired profiles of the lower film 21. Openings, destined to become the connection openings to the Ti layer 155 at the connectors 80-83, are formed in the SiN layer 158. Then, an Al layer 159, destined to become the connectors 80-83 and the “upper” film 22 of the displaceable members 4, 5, 8, 9, is deposited by vapor deposition or the like. The Al layer 159 is patterned by photolithography and etching in the desired profiles of the upper films 22 (FIG. 47).

In FIG. 47, lines corresponding to hidden structure (e.g., obscured by the polyimide film 157) and that otherwise would be denoted by dashed lines are shown using solid lines. Actual structure can be ascertained from FIGS. 56-58.

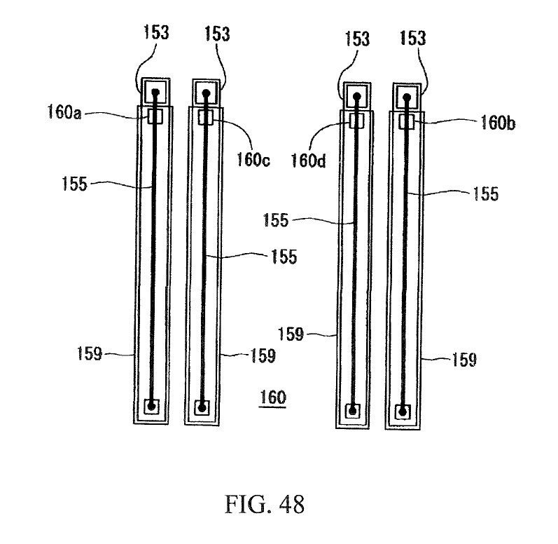

A “temporary” layer 160 of resist is applied to the entire surface of the substrate, in the condition shown in FIG. 47. Openings 160a-160d are formed, by photolithography and etching, in the resist layer 160 that correspond with the connectors 70-73 (FIG. 48). In FIG. 48, lines corresponding to hidden structure (e.g., obscured by the resist layer 160) and that otherwise would be denoted by dashed lines are shown using solid lines. Actual structure can be ascertained from FIGS. 56-58.

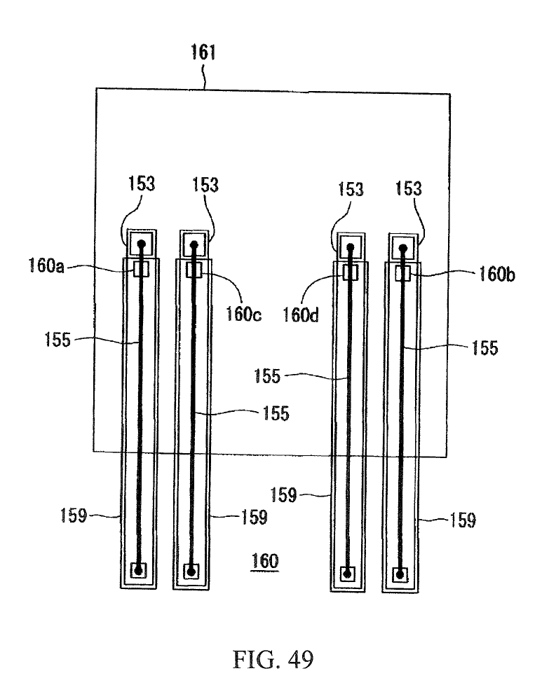

Next, the entire surface of the substrate, in the condition shown in FIG. 48, is coated with a sacrificial polyimide film 161 applied by spin coating or the like. Portions of the polyimide film 161 (including respective regions corresponding to the openings 160a-160d ) are removed by photolithography and etching. After such patterning, an island of the polyimide film 161 is left in a region corresponding to the planar portion 10a of the response electrode 10 (FIG. 49). In FIG. 49, lines corresponding to hidden structure (e.g., obscured by the polyimide layer 161) and that otherwise would be denoted by dashed lines are shown using solid lines. Actual structure can be ascertained from FIGS. 56-58.

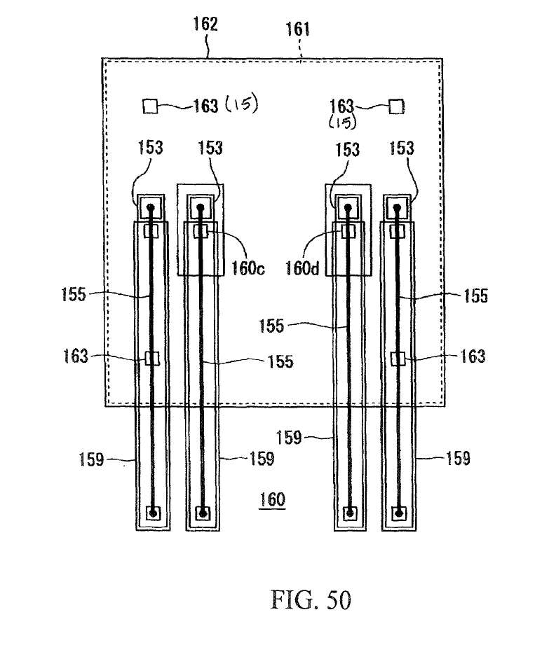

A layer 162 of Al, destined to become the response electrode 10 and connectors 70, 71, is deposited by vapor deposition or the like. The Al layer 162 is patterned by photolithography and etching to the desired profiles of the response electrode 10. Patterning of the Al layer 162 is performed in a manner by which remaining regions of the Al layer 162 are slightly larger than the underlying islands of the polyimide layer 161. Thus, the planar portions 10a, side portions 10b, and (optionally) edge portions 10c of the response electrode 10 are formed. Next, a layer 163 of SiN, destined to become the insulating film 15, is deposited by P-CVD or the like. The SiN layer 163 is patterned by photolithography and etching to define the desired regions of insulating film 15 (FIG. 50).

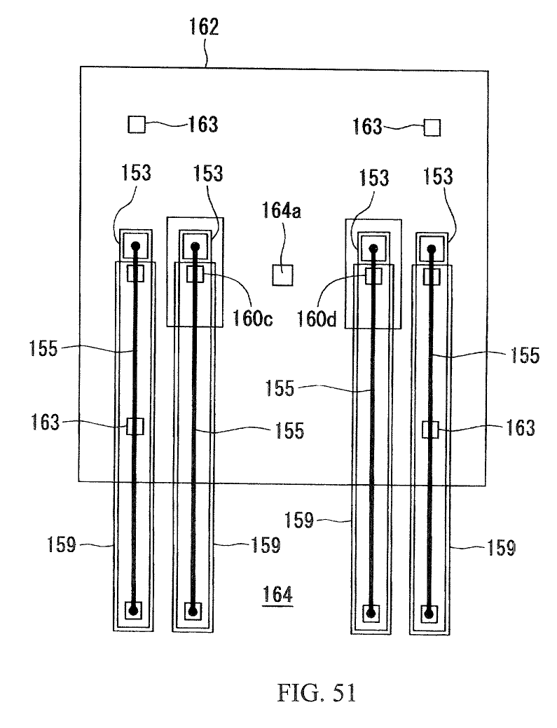

Next, the entire surface of the substrate, in the condition shown in FIG. 50, is coated with a sacrificial polyimide film 164, applied by spin coating or the like. An opening 164a, corresponding to the connector 74, is formed in the polyimide layer 164 by photolithography and etching. In the same step, any polyimide film 164 that has entered the openings 160c, 160d is removed (FIG. 51). In FIG. 51, lines corresponding to hidden structure (e.g., obscured by the polyimide layer 164) and that otherwise would be denoted by dashed lines are shown using solid lines. Actual structure can be ascertained from FIGS. 56-58.

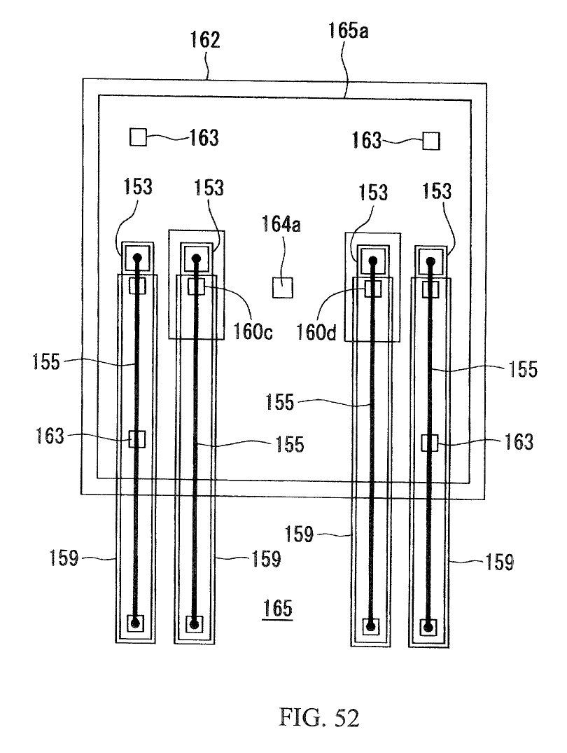

A “temporary” resist layer 165 is applied to the entire surface of the substrate, in the condition shown in FIG. 51. An opening 165a, corresponding to the planar portion of the reference electrode 11, is formed in the resist 165 by photolithography and etching (FIG. 52). In the same step, any resist 165 that has entered the openings 160c, 160d, and 164a is removed. In FIG. 52, lines corresponding to hidden structure (e.g., obscured by the resist layer 165) and that otherwise would be denoted by dashed lines are shown using solid lines. Actual structure can be ascertained from FIGS. 56-58.

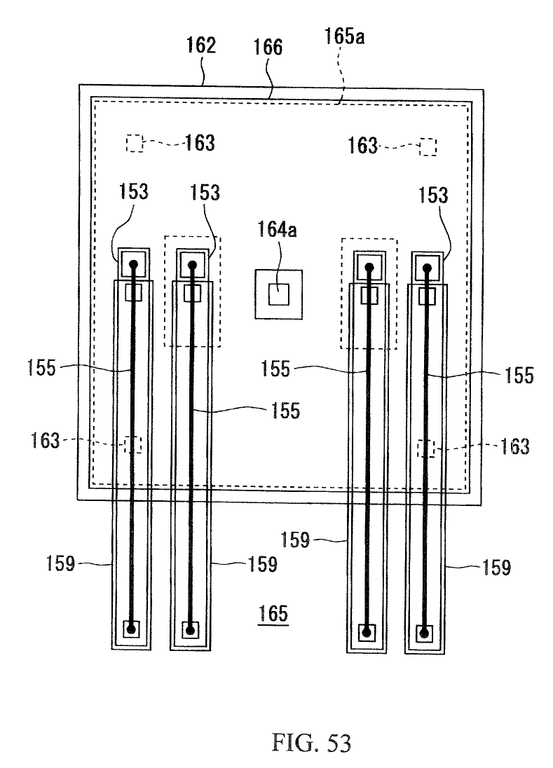

A layer 166 of Al, destined to become the reference electrode 11 and connectors 72, 73, is deposited by vapor deposition or the like. The Al layer is patterned by photolithography and etching into the profile of the reference electrode 11 (FIG. 53). As a result of this patterning, areas of the Al layer 166 that are left are sized slightly larger than the opening 165a in the resist 165. As a result, the planar portion 11a, side portions 11b, and (optionally) edge portions 11c of the reference electrode 11 are formed (FIGS. 56-58).

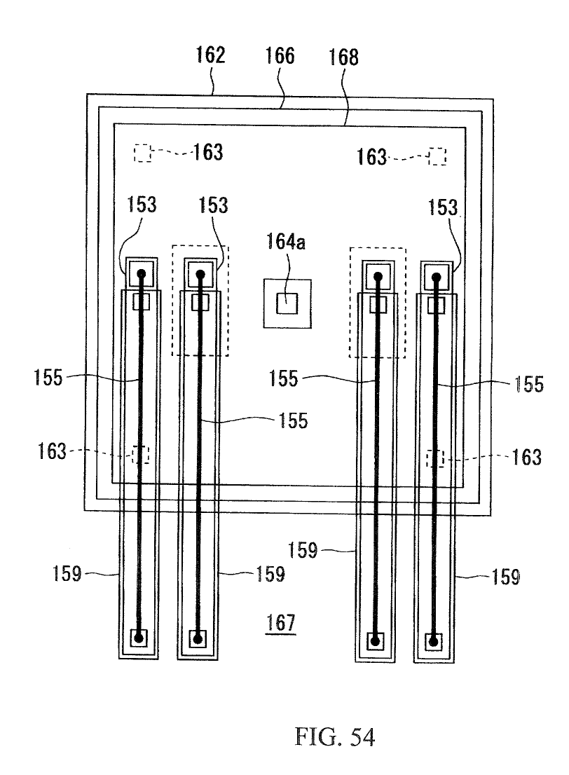

Next, the entire surface of the substrate, in the condition shown in FIG. 53, is coated with a sacrificial polyimide film 167 applied by spin coating or the like. Any of the polyimide film 167 that has entered the opening 164a is removed by photolithography and etching. A “temporary” layer 168 of resist is applied to the entire surface of the substrate, in this condition. All of the resist 167 is removed (including an area corresponding to the opening 164a), by photolithography and etching, except for an island of resist 168 that corresponds with the planar portion 12a of the radiation absorber 12 (FIG. 54).

A layer 169 of SiN, destined to become the radiation absorber 12 and the connector 74, is deposited by P-CVD or the like. The SiN layer 169 is patterned by photolithography and etching into the profile of the radiation absorber 12 (FIGS. 55-58). The area of the SiN layer 169 that is left after patterning is slightly larger than the corresponding region of the resist layer 168. Thus, the planar portion 12a, side portions 12b, and (optionally) edge portions 12c of the radiation absorber 12 are formed.

Finally, the substrate in this condition is cut into individual chips by dicing or the like. All the “temporary” layers of resist 151, 160, 165, 168 and the sacrificial layers of polyimide 152, 157, 161, 164, 167 are removed by ashing or the like to complete fabrication of the radiation detector of this embodiment.

This embodiment yields the same benefits as the first representative embodiment. In addition, in this embodiment, the legs 2, 3, 6, 7, displaceable members 4, 5, 8, 9, response electrode 10, reference electrode 11, and radiation absorber 12 are “stacked” in the Z-axis direction. As a result, the respective surface areas of the radiation absorber 12 and the electrodes 10, 11 can be made larger within a given pixel region, to improve detection sensitivity. This embodiment also reduces lateral spread of the overall detector, thereby producing pixel structures having good overall structural balance and high mechanical strength, while improving the fill factor of the detector compared to conventional detectors.

It will be understood that modifications, such as those described above, by which the first representative embodiment was modified to yield the third through fifth representative embodiments can be made in a similar manner to the sixth representative embodiment.

With a radiation detector according to the invention, as described above, the inter-electrode gap can be set to a desired distance, thereby enabling desired sensitivity characteristics and dynamic range in radiation detection to be achieved.

In addition, with this invention, changes in the electrical capacitance between the electrodes due to changes in the ambient temperature can be suppressed better than with conventional radiation detectors. Hence, even when strict temperature control of the detector is not performed, radiation detection is performed with greater accuracy than with conventional detectors.

Whereas the invention has been described in connection with multiple representative embodiments, it will be understood that the invention is not limited to those embodiments. On the contrary, the invention is intended to encompass all modifications, alternatives, and equivalents as may be included within the spirit and scope of the invention, as defined by the appended claims.

What is claimed is:

1. A radiation detector including a substrate on which at least one unit pixel is formed, the unit pixel comprising:
first and second displaceable members attached to the substrate and having similar respective thermally bimorphous structures;
a first electrode attached to the first displaceable member and a second electrode attached to the second displaceable member such that at least a portion of the second electrode faces the first electrode;
a radiation absorber configured to absorb incident radiation to be detected, the radiation absorber being thermally coupled to the first displaceable member but substantially not to the second displaceable member so as to enable the radiation absorber, when heated by absorption of incident radiation, to transfer heat to the first displaceable member but substantially not to the second displaceable member;
each of the first and second displaceable members including at least a first and a second layer laminated together in a stacking direction normal to the substrate to form the respective thermally bimorphous structure, the first and second layers being formed of respective first and second materials having different respective coefficients of thermal expansion so as to cause a displaceable member to exhibit a bending response when heated, the bending response in one displaceable member but substantially not in the other resulting in a change in a gap distance between the first and second electrodes;
the first and second electrodes being configured to allow an electrical capacitance to be measured between the first and second electrodes, the electrical capacitance exhibiting a change with a respective change in the gap distance; and
the first and second displaceable members being situated relative to each other such that the first and second layers of each of the first and second displaceable members are formable simultaneously during respective fabrication steps.

2. The radiation detector of claim 1, wherein the first and second displaceable members do not overlap each other when viewed from a position along the stacking direction.

3. The radiation detector of claim 1, wherein the first and second displaceable members are situated parallel to each other.

4. The radiation detector of claim 1, further comprising a radiation reflector, wherein:
the radiation absorber reflects a portion of radiation incident to it; and
the radiation reflector is situated relative to the radiation absorber to define a gap of substantially nλ₀/4 between the radiation absorber and the radiation reflector, wherein n is an odd integer and λ₀ is the center wavelength of a wavelength band of radiation detectable by the radiation detector.

5. The radiation detector of claim 4, wherein:
the radiation reflector is one of the first and second electrodes; and
the radiation absorber is situated in the stacking direction relative to the first and second electrodes.

6. The radiation detector of claim 5, wherein:
the first and second electrodes and the radiation absorber are aligned with each other and arranged in the stacking direction in an order of (a) radiation absorber, first electrode, then second electrode, or (b) radiation absorber, second electrode, then first electrode; and
the first displaceable member, when heated, exhibits a bending response that that displaces the second electrode away from the first electrode.

7. The radiation detector of claim 1, wherein:
the first electrode comprises a planar portion and a side portion, the planar portion having a periphery and the side portion extending at least partially around the periphery, the side portion projecting from the planar portion away from the second electrode; and
the second electrode comprises a planar portion and a side portion, the planar portion having a periphery and the side portion extending at least partially around the periphery, the side portion extending from the planar portion away from the first electrode.

8. The radiation detector of claim 1, wherein one of the first and second electrodes is affixed via a support frame to the respective first or second displaceable member, the support frame being made of a thermally insulative material and comprising a planar portion having a periphery, the side portion being configured to extend from the planar portion along at least a portion of the periphery.

9. The radiation detector of claim 1, further comprising an electrically insulative film situated between the first electrode and the second electrode.

10. The radiation detector of claim 1, further comprising first and second legs, wherein the first displaceable member is mounted to the substrate via the first leg, and the second displaceable member is mounted to the substrate via the second leg.

11. The radiation detector of claim 10, wherein:
each leg has a respective length direction, start point, and end point;
with respect to the first leg, a distance along the respective length direction from the respective start point to the respective end point is substantially equal to, with respect to the second leg, a distance along the respective length direction from the respective start point to the respective end point.

12. The radiation detector of claim 11, wherein:
the end point of the first leg is located in the first displaceable member; and
the end point of the second leg is located in the second displaceable member.

13. The radiation detector of claim 10, wherein:
each leg has a respective length direction, start point, and end point;
with respect to the second leg, a distance along the respective length direction from the respective start point to the respective end point is shorter than, with respect to the first leg, a distance along the respective length direction from the respective start point to the respective end point.

14. The radiation detector of claim 13, wherein the second leg has zero length, along the length direction, between the start point and the end point.

15. The radiation detector of claim 10, wherein the first and second legs, the first and second displaceable members, the first and second electrodes, and the radiation absorber are disposed in the stacking direction with respective intervening spaces therebetween.

16. The radiation detector of claim 1, wherein:
each of the first and second displaceable members has a width direction, a respective start point, and a respective end point; and
the start point of the first displaceable member and the start point of the second displaceable member have substantially identical positions when viewed from the width direction of the first and second displaceable members.

17. The radiation detector of claim 1, wherein:
each of the first and second displaceable members has a width direction, a respective start point, and a respective end point; and
the start point of the first displaceable member and the start point of the second displaceable member are shifted relative to each other to form a gap between the first and second displaceable members, the gap being narrowed when viewed from the width direction of the first and second displaceable members.

18. A radiation detector including a substrate on which at least one unit pixel is formed, the unit pixel comprising:
first and second displaceable members attached to the substrate and having similar respective thermally bimorphous structures;
a first electrode attached to the first displaceable member and a second electrode attached to the second displaceable member such that at least a portion of the second electrode faces the first electrode;
a radiation absorber configured to absorb incident radiation to be detected, the radiation absorber being thermally coupled to the first displaceable member but substantially not to the second displaceable member so as to enable the radiation absorber, when heated by absorption of incident radiation, to transfer heat to the first displaceable member but not to the second displaceable member;
each of the first and second displaceable members including at least a first and a second layer laminated together in a stacking direction perpendicular to the substrate to form the respective thermally bimorphous structure, the first and second layers being formed of respective first and second materials having different respective coefficients of thermal expansion so as to cause a respective displaceable member to exhibit a bending response when heated, the bending response causing a change in a gap distance between the first and second electrodes;
the first and second electrodes being configured to allow an electrical capacitance to be measured between the first and second electrodes, the electrical capacitance exhibiting a change with a respective change in the gap distance; and
the first and second displaceable members being situated relative to each other without mutual overlap when viewed from a direction normal to the substrate.

19. In a method for fabricating, on a substrate, a radiation detector including at least one unit pixel, the method comprising for each pixel of the detector:
in a first layer-forming step, forming a first layer, of a first material having a respective coefficient of thermal expansion, of each of first and second displaceable members;
in a second layer-forming step, forming a second layer, of a second material having a respective coefficient of thermal expansion that is different from the coefficient of thermal expansion of the first material, of each of the first and second displaceable members to form respective thermally bimorphous structures in which the respective first and second layers are laminated together;
forming a first electrode attached to the first displaceable member;
forming a second electrode attached to the second displaceable member such that at least respective portions of each of the first and second electrodes face each other in a stacking direction with a space therebetween, and such that an electrical capacitance can be measured between the first and second electrodes; and
forming a radiation absorber in a manner and location such that the radiation absorber is thermally coupled to the first displaceable member but not to the second displaceable member, the radiation absorber being formed of a material that absorbs incident radiation that causes heating of the radiation absorber with resultant conduction of the heat to the first displaceable member.

20. The method of claim 19, wherein the first electrode, second electrode, and radiation absorber are formed in an order, from the substrate in a stacking direction, of first electrode, second electrode, and radiation absorber.

21. The method of claim 19, wherein the first electrode, second electrode, and radiation absorber are formed in an order, from the substrate in a stacking direction, of second electrode, first electrode, and radiation absorber.

22. The method of claim 19, wherein the first electrode, second electrode, and radiation absorber are formed in an order, from the substrate in a stacking direction, of radiation absorber, first electrode, and second electrode.

23. The method of claim 19, wherein the first electrode, second electrode, and radiation absorber are formed in an order, from the substrate in a stacking direction, of radiation absorber, second electrode, and first electrode.

24. The method of claim 19, wherein the first and second displaceable members are formed parallel to each other.

25. The method of claim 19, further comprising the steps of:
forming a first leg attaching the first displaceable member to the substrate; and
forming a second leg attaching the second displaceable member to the substrate.

26. The method of claim 19, further comprising the step of forming each of the first electrode, the second electrode, and the radiation absorber with a respective planar portion extending parallel to the substrate and having a respective periphery, and a respective side portion extending along at least a portion of the respective periphery.

27. The method of claim 19, further comprising the step, between forming the first and second electrodes, of forming an electrically insulative layer configured to be situated between the first and second electrodes.
